(19) United States
(12) Patent Application Publication
(10) Pub. No.: US 2025/0076723 A1
(43) Pub. Date: Mar. 6, 2025

(54) Electrophoretic Particles Comprising an Organic Pigment and Graphene Oxide

(71) Applicant: E Ink Corporation, Billerica, MA (US)

(72) Inventor: Saemi Oh POELMA, Sunnyvale, CA (US)

(21) Appl. No.: 18/808,857

(22) Filed: Aug. 19, 2024

Related U.S. Application Data
(60) Provisional application No. 63/579,431, filed on Aug. 29, 2023.

(51) Int. Cl. G02F 1/167; C09B 67/08; C09B 67/20; G02F 1/1675

(52) U.S. Cl. CPC G02F 1/167; C09B 67/0007; C09B 67/0013; C09B 67/0069; G02F 2001/1678

(57) ABSTRACT

An electrophoretic medium comprises a plurality of a first type of charged particles in a non-polar liquid. Each of the plurality of the first type of charged particles has a core and a shell. The core comprises an organic pigment and a graphene oxide layer. The shell comprises an organosilane layer and a polymeric layer. The electrophoretic medium may be incorporated in a color electrophoretic device to improve its electro-optic performance.

### RELATED APPLICATIONS

This application claims priority to U.S. Provisional Patent Application No. 63/579,431 filed on Aug. 29, 2023, which is incorporated by reference in its entirety, along with all other patents and patent applications disclosed herein.

### FIELD OF THE INVENTION

This invention relates to an electrophoretic medium for electro-optic displays, the electrophoretic medium comprising a non-polar liquid and charged particles. Each particle has a core and a shell, the core comprising an organic pigment and graphene oxide, and the shell comprising an organosilane layer and a polymeric layer.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media is susceptible to the same types of problems due to particle settling as liquid-based electrophoretic media, when the media are used in an orientation which permits such settling, for example in a sign where the medium is disposed in a vertical plane. Indeed, particle settling appears to be a more severe problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids, and fluid additives; see for example U.S. Pat. Nos. 6,822,782; 7,002,728; 7,679,814; 8,018,640; 8,199,395; 9,372,380; 10,825,586; and 11,099,452; and U.S. Patent Application Publication Nos. 2018/0210312; and 2021/0247658;
(b) Capsules, binders, and encapsulation processes; see for example U.S. Pat. Nos. 6,922,276; and 7,411,719;
(c) Microcell structures, wall materials, and methods of forming microcells; see for example U.S. Pat. Nos. 7,072,095; and 9,279,906;
(d) Methods for filling and sealing microcells; see for example U.S. Pat. Nos. 7,144,942; and 7,715,088;
(e) Films and sub-assemblies containing electro-optic materials; see for example U.S. Pat. Nos. 6,982,178; and 7,839,564;
(f) Backplanes, adhesive layers and other auxiliary layers and methods used in displays; see for example U.S. Pat. Nos. 7,116,318; 7,535,624;
(g) Color formation and color adjustment; see for example U.S. Pat. Nos. 7,075,502 and 7,839,564;
(h) Methods for driving displays; see for example U.S. Pat. Nos. 7,012,600; and 7,453,445;
(i) Applications of displays; see for example U.S. Pat. Nos. 7,312,784; 8,009,348;
(j) Non-electrophoretic displays, as described in U.S. Pat. No. 6,241,921; and 2015/0277160; and applications of encapsulation and microcell technology other than displays; see for example U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6, 144, 361; 6, 172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

The image quality of the image of an electrophoretic device comprising electrophoretic medium having charged pigment particles in a non-polar liquid may be reduced because charge particles of the electrophoretic medium may aggregate, especially in the case where the charged particles comprise organic pigments. This particle aggregation may take place between charged particles of the same color or between charged pigment particles of different types, that is, between charged particles having different colors. For example, an electrophoretic medium may contain charged particles comprising pigments of four different colors, such as blue, red, yellow, and white. In such electrophoretic media, aggregation between blue-red and blue-yellow particles prevents complete separation between electrophoretic particles during the device operation, leading to less chromatic color states of the device. The aggregation between organic pigment particles may be somewhat mitigated if the blue pigment that is used is an inorganic pigment. However, blue inorganic pigment does not provide images having saturated colors. Thus, there is a need to improve charged particles that are used in electrophoretic media. The inventor of the present invention surprisingly found that using charged particles having a core and a shell, wherein the charged particles comprise (1) a core comprising an organic pigment and a graphene oxide layer, and (2) a shell comprising an organosilane layer and a polymeric layer, significantly improve the color saturation of the colors states that can be achieved by the device.

### SUMMARY OF THE INVENTION

According to one aspect of the present invention, an electrophoretic medium comprises a plurality of a first type of charged particles and a non-polar liquid. Each of the plurality of the first type of charged particles has a core and a shell. The core comprises a first type of organic pigment having a surface and a graphene oxide layer comprising graphene oxide. The graphene oxide of the graphene oxide layer is in contact with the surface of the first type of organic pigment. The shell comprises an organosilane layer comprising an organosilane, and a polymeric layer comprising a polymer. The organosilane of the organosilane layer is covalently bonded to the polymer of the polymeric layer.

The core of the first type of charged particles may comprise a metal oxide layer comprising a metal oxide. The metal oxide layer is disposed between the graphene oxide layer of the core and the organosilane layer of the shell. The metal oxide layer may comprise aluminum oxide, silica, titanium dioxide, zirconium oxide, zinc oxide or mixtures thereof.

The metal oxide of the metal oxide layer of the first type of charged particles may be formed on the graphene oxide of the core by a reaction of a metal oxide precursor and a reagent. The reagent reacts with the metal oxide precursor to form the metal oxide. The metal oxide precursor may be selected from the group consisting of trimethylaluminum, triethylaluminum, dimethylaluminum chloride, diethylaluminum chloride, trimethoxyaluminum, tricthoxyaluminum, dimethylaluminum propoxide, aluminum triisopropoxide, tributoxy aluminum, tris(dimethylamino) aluminum, tris(diethylamino) aluminum, tris(propylamino) aluminum, aluminum trichloride, trichlorosilane, hexachlorodisilane, silicon tetrachloride, tetramethoxysilane, tetraethoxysilane, tris(tert-pentoxy) silanol, tetraisocyanatesilane, silicon tertrachoride, tris(methylamino)silane, tris(ethylamino)silane, titanium tetrachloride, titanium tetraiodide, tetramethoxy titanium, tetraethoxy titanium, titanium isopropoxide, tetrakis(methylamino) titanium, tetrakis(ethylamino) titanium, dimethyl zinc, diethyl zinc, methyl zinc isopropoxide, zirconium tetrachloride, zirconium tetraiodide, tetramethoxy zirconium, tetraethoxy zirconium, tetraisopropoxy zirconium, tetrabutoxy zirconium, tetrakis(methylamino) zirconium, tetrakis(ethylamino) zirconium, and mixtures thereof. The reagent may be selected from the group consisting of water, oxygen, ozone, ammonia, and mixture thereof. The organosilane layer is covalently bonded to the metal oxide of the metal oxide layer.

The organosilane layer may be formed from an organosilane reagent. The organosilane reagent may comprise a first functional group. If the first type of charged particle comprises a metal oxide, the first functional group of the organosilane reagent may react with the metal oxide of the metal oxide layer to form a covalent bond between the organosilane of the organosilane layer and the metal oxide of the metal oxide layer of the first type of charged particles. The first functional group of the organosilane reagent may be selected from the group consisting of alkoxy, alkylamino, halide, hydrogen, and hydroxy. The molecular structure of the organosilane reagent may contain more than one alkoxy, alkylamino, halide, hydrogen, or hydroxy functional groups. The molecular structure of the organosilane reagent may contain one, two, or three alkoxy functional groups. The molecular structure of the organosilane reagent may contain one, two, or three halide functional groups. The molecular structure of the organosilane reagent may contain one, two, or three hydroxy functional groups.

The polymer of the polymeric layer may be formed from a macromonomer or from polymerization of a monomer. The polymer of the polymeric layer may be covalently bonded to the organosilane of the organosilane layer. The organosilane reagent may comprise a second functional group. The macromonomer or the monomer may comprise a third functional group. The second functional group of the organosilane reagent may react with the third functional group of the macromonomer or monomer to form a covalent bond between the organosilane of the organosilane layer and the polymer of the polymeric layer of the first type of charged particles. The second functional group of the organosilane reagent may be selected from the group consisting of epoxy, vinyl, vinylbenzyl, acryloyl, methacryloyl, methacryloxyakyl, amino, hydroxy, carboxy, alkoxy group, and chloride. The third functional group of the monomer or macromonomer may be selected from the group consisting of vinyl, vinylbenzyl, acryloyl, methacryloyl, methacryloxyakyl, epoxy, amino, hydroxy, carboxy, and chloride. The second functional group of the organosilane may be vinyl, and the third functional group of the macromonomer or monomer may be vinylbenzyl.

The electrophoretic medium may comprise, in addition to the plurality of the first type of charged particle, a plurality of a second type of charged particles, a plurality of a third type of charged particles, and a plurality of a fourth type of charged particles. Each of the plurality of the second type of charged particles may comprise a second type of organic pigment. Each of the plurality of the third type of charged particles may comprise a third type of organic pigment. Each of the plurality of the fourth types of charged particles may comprise an inorganic pigment.

The organic pigment of the first type of charge particles may be selected from the group consisting of an azo pigment, a phthalocyanine pigment, a quinacridone pigment, a perylene pigment, a diketopyrrolopyrrole pigment, a benzimidazolone pigment, an isoindoline pigment, an anthranone pigment, an indanthrone pigment, a carbon black pigment, a rhodamine pigment, a benzinamine pigment, a carbon black pigments, and mixtures therein. The organic pigment of the first type of charged particles, the second type of charged particles, and the third type of charged particles may be independently selected from the group consisting of C.I. Pigment Blue 15, 15:1, 15:2, 15:3, 15:4 15:6, 60, and 79; Pigment Red 2, 4, 5, 9, 12, 14, 38, 48:2, 48:3, 48:4, 52:2, 53:1, 57:1, 81, 112, 122, 144, 146, 147, 149, 168, 170, 176, 177, 179, 184, 185, 187, 188, 208, 209, 210, 214, 242, 254, 255, 257, 262, 264, 282, and 285; C.I. Pigment Violet 1, 19, 23, and 32; C.I. Pigment Yellow 1, 3, 12, 13, 14, 15, 16, 17, 73, 74, 81, 83, 97, 109, 110, 111, 120, 126, 127, 137, 138, 139, 150, 151, 154, 155, 174, 175, 176, 180, 181, 184, 191, 194, 213 and 214; C.I. Pigment Green 7, and 36; C.I. Pigment Black 1, and 7; C.I. Pigment Brown 25, 32, 41; Pigment Orange 5, 13, 34, 36, 38, 43, 61, 62, 64, 68, 67, 72, 73, and 74, and mixtures thereof.

According to another aspect of the present invention, an electrophoretic device comprises a first light-transmissive electrode layer, an electro-optic material layer comprising an electrophoretic medium, and a second electrode layer. The electrophoretic medium comprises a plurality of a first type of charged particles and a non-polar liquid. Each of the plurality of the first type of charged particles has a core and a shell. The core comprises a first type of organic pigment having a surface, and a graphene oxide layer comprising graphene oxide. The graphene oxide of the graphene oxide layer is in contact with the surface of the first type of organic pigment. The shell comprises an organosilane layer comprising an organosilane, and a polymeric layer comprising a polymer. The organosilane of the organosilane layer may be covalently bonded to the polymer of the polymeric layer. The core of the first type of charged particles may also comprise a metal oxide layer comprising a metal oxide. The metal oxide layer may be disposed between the graphene oxide layer and the organosilane layer. The organosilane of the organosilane layer of the shell may be covalently bonded to the metal oxide of the metal oxide layer. The metal oxide layer may comprise aluminum oxide, silica, titanium dioxide, zirconium oxide, zinc oxide or mixtures thereof. The polymer of the polymeric layer may be formed from a macromonomer or from polymerization of a monomer. The polymer of the polymeric layer may be covalently bonded to the organosilane of the organosilane layer. The organosilane reagent may comprise a second functional group. The macromonomer or the monomer may comprise a third functional group. The second functional group of the organosilane reagent may react with the third functional group of the macromonomer or monomer, forming a covalent bond between the organosilane of the organosilane layer and the polymer of the polymeric layer of the first type of charged particles. The second functional group of the organosilane reagent may be selected from the group consisting of epoxy, vinyl, vinylbenzyl, acryloyl, methacryloyl, methacryloxyakyl, amino, hydroxy, carboxy, alkoxy group, and chloride. The third functional group of the monomer or macromonomer may be selected from the group consisting of vinyl, vinylbenzyl, acryloyl, methacryloyl, methacryloxyakyl, epoxy, amino, hydroxy, carboxy, and chloride. The second functional group of the organosilane may be vinyl, and the third functional group of the macromonomer or monomer may be vinylbenzyl. The electrophoretic medium may comprise, in addition to the plurality of the first type of charged particle, a plurality of a second type of charged particles, a plurality of a third type of charged particles, and a plurality of a fourth type of charged particles. Each of the plurality of the second type of charged particles may comprise a second type of organic pigment. Each of the plurality of the third type of charged particles may comprise a third type of organic pigment. Each of the plurality of the fourth type of charged particles may comprise an inorganic pigment.

According to another aspect of the present invention, an electrophoretic assembly comprises in order: a first light-transmissive electrode layer, an electro-optic material layer comprising encapsulated electrophoretic medium, an adhesive layer, and a release sheet. The electrophoretic medium comprises a non-polar liquid and a plurality of a first type of charged particles, the first type of charged particles having a structure as described above.

According to another aspect of the present invention, an electrophoretic assembly comprising in order: a first release sheet, a first adhesive layer, an electro-optic material layer comprising encapsulated electrophoretic medium, an adhesive layer, a second adhesive layer, and a second release sheet. The electrophoretic medium comprises a non-polar liquid and a plurality of a first type of charged particles, the first type of charged particles having a structure as described above.

According to yet another aspect of the present invention, a method of manufacturing of an electrophoretic medium. The electrophoretic medium comprises a non-polar liquid and a plurality of a first type of charged particles having a core and a shell. The method of manufacturing comprising the steps: (a) providing graphene oxide, (b) dispersing the graphene oxide into a polar organic solvent to make a graphene oxide dispersion, (c) adding an organic pigment into the graphene oxide dispersion to prepare an organic pigment-graphene oxide dispersion, (d) mixing the organic pigment-graphene oxide dispersion to prepare an organic pigment-graphene oxide complex in the polar organic solvent, (e) adding a metal oxide precursor and a reagent into the organic pigment-graphene oxide complex in the polar organic solvent to prepare a dispersion of particles comprising organic pigment-graphene oxide complex having a metal oxide layer, the metal oxide layer comprising a metal oxide, (f) adding an organosilane reagent into the dispersion of particles comprising the organic pigment-graphene oxide complex having a metal oxide layer to prepare a dispersion having particles comprising the organic pigment-graphene oxide complex having a metal oxide layer, and an organosilane layer, the organosilane layer having an organosilane, wherein the organosilane is covalently bonded to the metal oxide, (g) separating the particles comprising the organic pigment-graphene oxide complex having the metal oxide layer and an organosilane layer from the polar organic solvent, (h) washing the particles comprising the organic pigment-graphene oxide complex having a metal oxide layer, and an organosilane layer with a solvent, (i) transferring the washed particles comprising the organic pigment-graphene oxide complex having a metal oxide layer, and an organosilane layer into a non-polar liquid to prepare a dispersion of particles comprising the organic pigment-graphene oxide complex having a metal oxide layer, and an organosilane layer in the non-polar liquid, (j) adding a monomer or macromonomer into the dispersion of particles comprising the organic pigment-graphene oxide complex having a metal oxide layer, and an organosilane layer in the non-polar liquid, and (k) polymerizing the monomer or reacting the macromonomer with the organosilane of the organosilane layer of the particles comprising the organic pigment-graphene oxide complex having the metal oxide layer and the organosilane layer to prepare a dispersion comprising the first type of charged particles in the non-polar liquid, each of the first type of charged particles comprising the organic pigment-graphene oxide complex having the metal oxide layer, the organosilane layer, and a polymeric layer, the polymeric layer comprising a polymer, the polymer being covalently bonded to the organosilane of the organosilane layer. The process may also comprise a step of (k) adding a charge control agent into the dispersion comprising the third type of charged particles in a non-polar liquid.

### BRIEF DESCRIPTION OF DRAWINGS

Various aspects and embodiments of the application will be described with reference to the following figures. It should be appreciated that the figures are not necessarily drawn to scale.

FIG. 1 is an illustration of a side view cross-section of an example of a first type of charged particle of the electrophoretic medium of the present invention, the charged particles having a core and a shell.

FIG. 2 is an illustration of a top view cross-section of an example of a first type of charged particle of the electrophoretic medium of the present invention, the charged particles having a core and a shell

FIG. 3 is an illustration of a side view cross-section of an example of a first type of charged particle of the electrophoretic medium of the present invention, the charged particles having a core and a shell, the core comprising a metal oxide layer.

FIG. 4 is an illustration of a top view cross-section of an example of a first type of charged particle of the electrophoretic medium of the present invention, the charged particles having a core and a shell, the core comprising a metal oxide layer

FIG. 5 shows a reaction scheme of the formation of an organic pigment-graphene oxide complex.

FIG. 6 shows a reaction scheme of the formation of an organic pigment-graphene oxide complex having a metal oxide layer.

FIG. 7 shows a reaction scheme of the formation of an organic pigment-graphene oxide complex having a metal oxide layer and an organosilane layer.

FIG. 8 shows a reaction scheme of the formation of an electrophoretic particle from an organic pigment-graphene oxide complex having a metal oxide layer and an organosilane layer.

FIG. 9 shows a reaction scheme of the preparation of a first type of charged particle comprising organic pigment, a graphene oxide layer, a silica layer, an organosilane layer, and a polymeric layer comprising polylauryl methacrylate.

FIG. 10A illustrates a side view cross-section of an example of electrophoretic device comprising an electro-optic material layer including electrophoretic medium in microcapsules.

FIG. 10B illustrates a side view cross-section of an example of electrophoretic device comprising an electro-optic material layer including electrophoretic medium in microcells.

FIG. 11 illustrates a side view cross-section of an example of a front plane laminate comprising a first light-transmissive layer, an electro-optic material layer including an encapsulated electrophoretic medium, an adhesive layer, and a release sheet.

FIG. 12 illustrates a side view cross-section of an example of a double release sheet comprising a first release sheet, a first adhesive layer, an electro-optic material layer comprising encapsulated electrophoretic medium, a second adhesive layer, and a second release sheet.

FIG. 13 shows a graph of reflectance of copper phthalocyanine pigment versus wavelength at the visible spectrum, and a graph of reflectance of inorganic ultramarine blue pigment versus wavelength at the visible spectrum.

### DETAILED DESCRIPTION OF THE INVENTION

The present invention provides an electrophoretic medium comprising a non-polar liquid and a plurality of a first type of charged particles. Each of the plurality of the first type of charged particles has a core and a shell. The core of the first type of charged particles comprises a first type of organic pigment having a surface and a graphene oxide layer comprising graphene oxide. The graphene oxide layer is in contact with the surface of the first type of organic pigment. The shell comprises an organosilane layer comprising an organosilane, and a polymeric layer comprising a polymer. The organosilane of the organosilane layer of the shell is bonded to the polymer of the polymeric layer. The organosilane of the organosilane layer of the shell may be covalently bonded to the polymer of the polymeric layer. The organosilane of the organosilane layer of the shell may be bonded to the polymer of the polymeric layer via an electrostatic bond. The polymeric layer is located on the outside surface of the shell of the first type of charged particles and it contributes to the dispersion stability of the first type of charged particles in the electrophoretic medium.

The core of the first type of charged particles may further comprise a metal oxide layer, which is disposed between the graphene oxide layer and the organosilane layer. The organosilane of the organosilane layer may be covalently bonded to the metal oxide of the metal oxide layer.

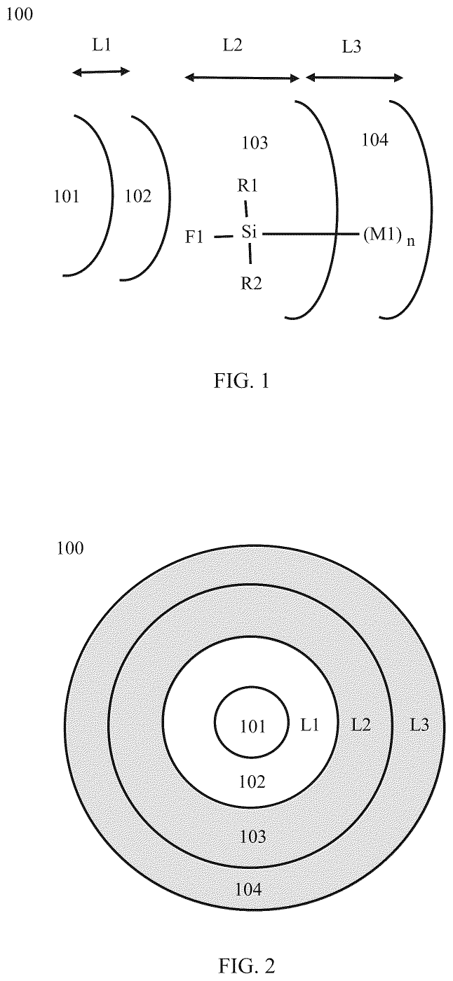

FIG. 1 illustrates a side view of a cross-section of an example of the first type of charged particles of the electrophoretic medium of the present invention. First type of charged particle 100 comprises first type of organic pigment 101, graphene oxide layer L1 comprising graphene oxide 102, organosilane layer L2 comprising organosilane 103, and polymeric layer L3 comprising polymer 104.

FIG. 2 is an illustration of a top view cross-section of an example of the first type of charged particles of the electrophoretic medium of the present invention. First type of charged particle 100 comprises first type of organic pigment 101, graphene oxide layer L1 comprising graphene oxide 102, organosilane layer L2 comprising organosilane 103, and polymeric layer L3 comprising polymer 104. The thickness of the various layers of the first type of charged particle 100 are not drawn in scale. The thicknesses of the various layers may be different from each other. Practically, a thickness of a layer of a charge particle may be different from a thickness of the same type of layer of another particle.

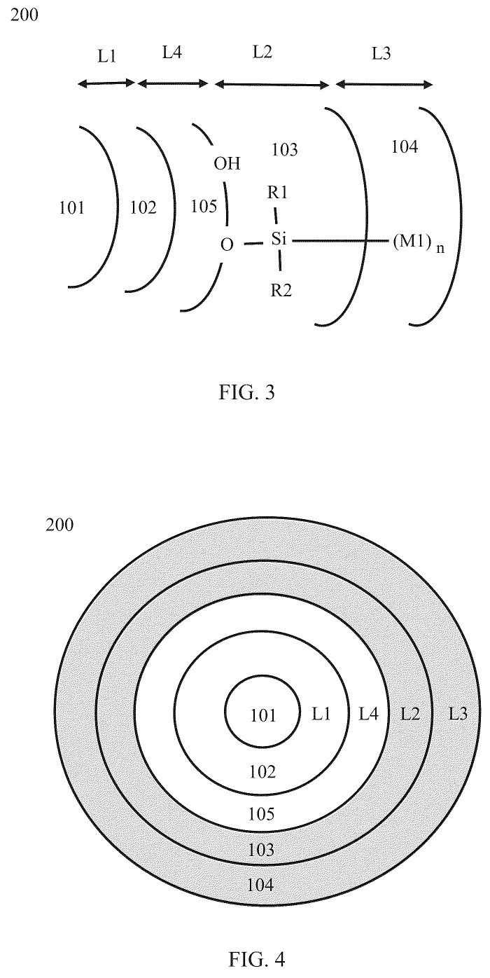

FIG. 3 illustrates a side view cross-section of an example of the first type of charged particles of the electrophoretic medium of the present invention, the core of the first type of charged particles further comprising a metal oxide layer. First type of charged particle 200 comprises first type of organic pigment 101, graphene oxide layer L1 comprising graphene oxide 102, metal oxide layer L4 comprising metal oxide 105, organosilane layer L2 comprising organosilane 103, and polymeric layer L3 comprising polymer 104.

FIG. 4 is an illustration of a top view cross-section of an example of the first type of charged particles of the electrophoretic medium of the present invention. First type of charged particle 100 comprises first type of organic pigment 101, graphene oxide layer L1 comprising graphene oxide 102, metal oxide layer L4 comprising metal oxide 105, organosilane layer L2 comprising organosilane 103, and polymeric layer L3 comprising polymer 104. The thickness of the various layers of first type of charged particle 200 are not drawn in scale. The thicknesses of the various layers may be different from each other. Practically, a thickness of a layer of a charge particle may be different from a thickness of the same type of layer of another particle.

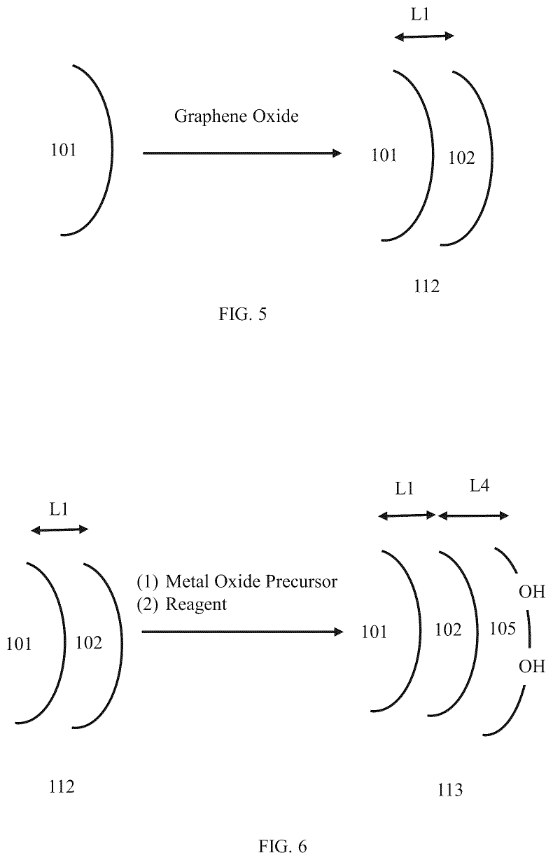

The first type of charged particles of the present invention may be manufactured using a multi-step process. An example of such a process is summarized in FIGS. 5-8. The first type of charged particles 200 that are manufactured by the process of FIGS. 5-8 comprise layers L1-L5.

The process involves treatment of the first type of organic pigment with graphene oxide. This step is illustrated in FIG. 5. Graphene oxide particles are first dispersed in a polar organic solvent, such as ethanol. The dispersion can be achieved by milling graphene oxide particles in the solvent using standard dispersion equipment such as a media mill, a sonicator, or other equipment. Then, particles of organic pigment 101 is slowly added into the graphene oxide dispersion under stirring conditions and the dispersion was heated under stirring at elevated temperatures (for example, at 50° C.) to prepare particles 112 comprising organic pigment-graphene oxide complex in the polar organic solvent. Each pigment-graphene oxide complex particle 112 includes a first type of organic pigment 101 and a graphene oxide layer L1, wherein graphene oxide layer L1 comprises graphene oxide 102. Graphene oxide layer L1 is in contact with the surface of the first type of organic pigment 101. The first type of organic pigment can be added into the graphene oxide dispersion as a dispersion that is prepared by milling organic pigment in a polar organic solvent using standard dispersion equipment such as a media mill, a sonicator, or other equipment. The polar organic solvent used for dispersing the organic pigment can be the same or different from the polar organic solvent used for the graphene oxide dispersion. Non-limiting examples of polar organic solvents that are used for the preparation of the organic pigment dispersion and the graphene oxide dispersion are methyl ethyl ketone, acetone, ethyl acetate, tetrahydrofurane, dimethyl formamide, ethyl ether, dimethyl sulfoxide, methanol, ethanol, isopropanol, and other solvents. The weight ratio of graphene oxide to organic pigment used for the preparation of particle 112 may be from 0.01 to 0.2, from 0.015 to 0.15, from 0.02 to 0.10, from 0.022 to 0.9, or from 0.025 to 0.8. The weight ratio of graphene oxide to organic pigment used for the preparation of particle 112 may be higher than 0.001, or higher than 0.01, or higher than 0.02, or higher than to 0.03, or higher than 0.05, or higher than 0.07. The weight ratio of graphene oxide to organic pigment used for the preparation of particle 112 may be lower than 0.15, or lower than 0.1, or lower than 0.7. Although first type of organic pigment 101 is shown in FIGS. 1-8 as a single particle, it is possible that an aggregate of organic pigment particles is included in the core.

The next step of the manufacturing of first type of charged pigment particles 200 is summarized in FIG. 6. It involves treatment of organic pigment-graphene oxide complex 112 with metal oxide precursor to form metal oxide layer L4, comprising metal oxide 105. During this step, organic pigment-graphene oxide complex 112 is treated with a metal oxide precursor and a reagent to form metal oxide layer L4 comprising metal oxide 105. This is achieved by starting with the dispersion of organic pigment-graphene oxide complex in polar organic solvent and adding a metal oxide precursor under mixing conditions, followed by the addition of a reagent into the dispersion, forming metal oxide 105 on the surface of the particles of organic pigment-graphene oxide complex 112. That is, the reagent reacts with the metal oxide precursor to form a metal oxide, which is precipitated on the surface of the particles of organic pigment-graphene oxide complex 112 to form a dispersion of particles 113 comprising organic pigment-graphene oxide complex having a metal oxide layer (L4). The weight ratio of metal oxide of the metal oxide layer to organic pigment in particles 113 may be from 0.1 to 1, from 0.2 to 0.9, from 0.3 to 0.8, or from 0.4 to 0.7. The weight ratio of metal oxide of the metal oxide layer to organic pigment in particles 113 may be higher than 0.05, or higher than 0.07, or higher than 0.1, or higher than 0.15, or higher than 0.30, or higher than 0.5. The weight ratio of metal oxide of the metal oxide layer to organic pigment in particles 113 may be lower than 0.5, or lower than 0.4, or lower than 0.3, or lower than 0.2.

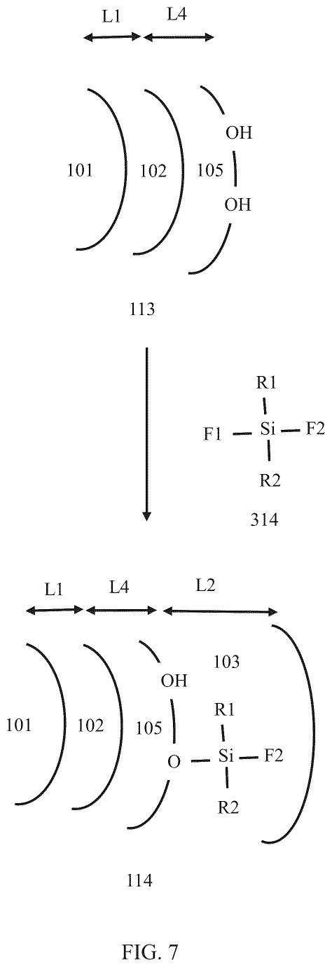

The next step of the manufacturing of the first type of charged pigment particles is summarized in FIG. 7. It involves treatment of particle 113 of organic pigment-graphene oxide complex having a metal oxide layer with an organosilane reagent 314 to form particle 114 comprising organic pigment-graphene oxide complex having metal oxide layer (L3), and an organosilane layer (L2). Organosilane reagent 314 has a first functional group F1, and a second functional group F2. As shown in FIG. 7, first functional group F1 of organosilane reagent 314 reacts with the metal oxide of the metal oxide layer of particle 113. Organosilane reagent 314 may have multiple functional groups that react with the metal oxide. That is, organosilane reagent may have two or more functional groups (same or different from F1) that react with the metal oxide. The weight ratio of organosilane of the organosilane layer to organic pigment in particles 114 may be from 0.005 to 0.3, from 0.01 to 0.2, from 0.015 to 0.18. The weight ratio of organosilane of the organosilane layer to organic pigment in particles 114 may be higher than 0.005, or higher than 0.01, or higher than 0.012, or higher than 0.015, or higher than 0.02. The weight ratio of organosilane of the organosilane layer to organic pigment in particles 114 may be lower than 0.3, or lower than 0.2, or lower than 0.1.

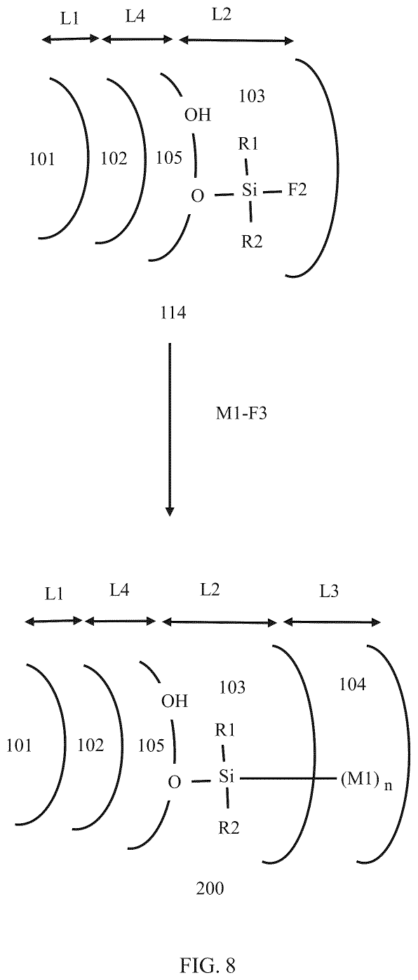

The next step of the manufacturing of the first type of charged pigment particles 100 is summarized in FIG. 8. Initially, the polar organic solvent of the dispersion, which is formed in a previous step of the process, is replaced by a non-polar liquid. This is achieved by initially separating the particles of organic pigment-graphene oxide complex having a metal oxide layer with an organosilane reagent (114) from the polar organic solvent by filtration, centrifugation, or other method. Particles 114 are washed once or more times with a solvent. After each wash, the particles are separated from the solvent by filtration, centrifugation, or other method. Then, the washed and separated particles 114 are transferred into a non-polar liquid to prepare a dispersion of particles comprising the organic pigment-graphene oxide complex having the metal oxide layer and the organosilane layer in the non-polar liquid. The dispersion is treated with a macromonomer or a monomer M1-F3 to form first type of charged particles 200. A polymer may be prepared in situ from a polymerization of monomer M1-F3 to form polymeric layer L3. The molecular structure of monomer M1-F3 comprises a functional group that participates in the polymerization of the monomer. This functional group may be the same or different from the third functional group. In other words, third functional group F3 of monomer M1-F3 may be the functional group that is used for the polymerization reaction of the monomer. Third functional group F3 may also participate in a reaction that forms a covalent bond between the polymer of the polymer layer and the organosilane of the organosilane layer via the reaction between functional group F3 and second functional group F2. In another example, a pre-polymerized macromonomer is used, instead of a monomer, to form the polymer layer. In this case, the molecular structure of macromonomer may also comprise third functional group F3 that reacts with second functional group F2 of the organosilane reagent. Thus, the materials of polymeric layer L3 and organosilane layer L2 may also be covalently bonded. In the absence of functional groups in the monomer or macromonomer that can react with any of the functional groups of the organosilane reagent to form a covalent bond, the polymer of polymeric layer L3 is physically adsorbed onto layer L2. However, there is a possibility of an electrostatic bond (or ionic bond) between the organosilane of the organosilane layer with the polymer of the polymeric layer, if the organosilane has a positive charge (or a partial positive charge) and the polymer has a negative charge (or partial negative charge). Analogously, an electrostatic bond may be formed between the organosilane of the organosilane layer with the polymer of the polymeric layer if the organosilane has a negative charge (or a partial negative charge) and the polymer has a positive charge (or partial positive charge). The resulting dispersion of the third type of charged particles in a non-polar liquid is the electrophoretic medium of the present invention. In another step, a charge control agent may be added into the dispersion of the third type of charged particles in a non-polar liquid.

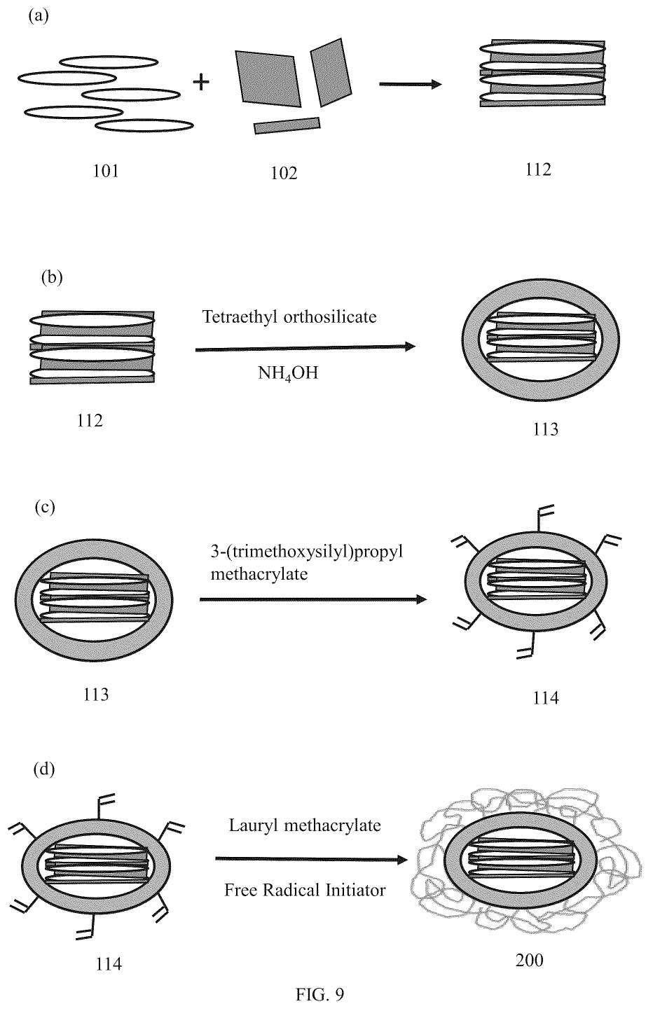

FIG. 9 illustrates an example of a process of making electrophoretic media comprising the first type of charged particle, wherein the first type of charged particles comprise an organic pigment 101, wherein the organic pigment may be copper phthalocyanine pigment, and specifically Pigment Blue 15:3. This pigment is well known and it is extensively used in the coatings industry, because of its light stability, high chroma, and good color strength.

The first step of the scheme of FIG. 9 involves the making of particles comprising copper phthalocyanine-graphene oxide complex in a polar organic solvent. As described above, particles comprising organic pigment-graphene oxide complex include an organic pigment having on its surface a graphene oxide layer comprising graphene oxide. In this example, the graphene oxide layer has thickness of from 300 to 800 nm.

The second step of the scheme of FIG. 9 involves the making of particles comprising organic pigment, graphene oxide layer, and a metal oxide layer comprising a metal oxide. The metal oxide is formed on the surface of the graphene oxide layer by in situ reaction of a metal oxide precursor and a reagent. In this example, the metal oxide precursor is tetraethyl orthosilicate (TEOS) and the reagent is aqueous ammonium hydroxide. The reaction between tetraethyl orthosilicate and water produces silica particles, which are precipitated onto the graphene oxide layer.

The third step of the scheme of FIG. 9 involves the formation of the organosilane layer. This step can take place in the same reaction vessel as the second step, and it involves the making of particles comprising organic pigment-graphene oxide complex, metal oxide layer (comprising silica), and an organosilane layer comprising an organosilane. The organosilane layer is formed from an organosilane reagent, which reacts with the metal oxide of the metal oxide layer. In this example, the organosilane reagent is 3-(trimethoxysilyl)propyl methacrylate. This organosilane reagent is supplied by Dow as a solution in methanol under the commercial code Z-6032 Silane. The molecular structure of Z-6032 Silane includes three methoxy functional groups that are connected to the silicon atom of the reagent. The methoxy groups of the organosilane reagent can react with the silica of the metal oxide layer, forming an organosilane layer comprising organosilane. Thus, the organosilane of the organosilane layer is covalently bonded to the silica of the metal oxide layer.

Finally, the fourth step of the scheme of FIG. 9 involves the formation of a polymeric layer, which contributes to the dispersion stability of the first type of charged particles in the electrophoretic medium. Before the formation of the polymeric layer, the polar organic solvent, in which the previous steps were performed, is replaced by a non-polar liquid by separating the particles from most of the polar organic solvent, washing the particles with as solvent as described above, and adding the non-polar liquid into the particles that comprise copper phthalocyanine pigment, graphene oxide layer, metal oxide layer (comprising silica), and organosilane layer. The formation of the polymeric layer is achieved by adding into the dispersion a monomer and a polymer initiator. In this case, the monomer is lauryl methacrylate, and the polymer initiator is 2,2′-azobis(2-methylpropionitrile) (AIBN). Lauryl methacrylate is polymerized under the conditions to provide poly(lauryl methacrylate) polymer. The vinyl functional group of the organosilane of the organosilane layer also participates, reacting with the carbon-carbon bond of the lauryl methacrylate (LMA). Thus, the polymeric layer is formed, wherein the poly(lauryl methacrylate) of the first type of charged particles is covalently bonded to the organosilane of the organosilane layer, as shown under Step 4 of FIG. 9 (graft polymerization).

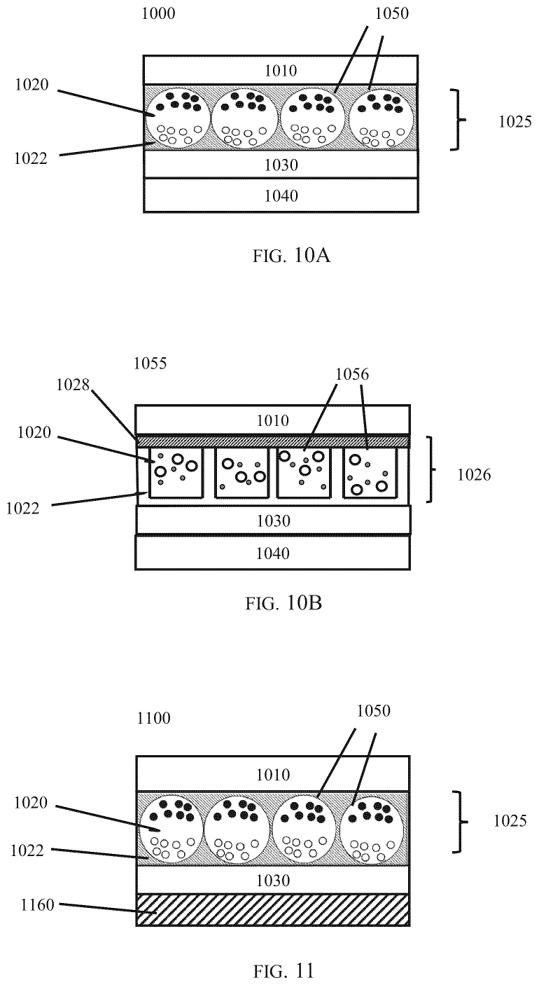

The electrophoretic medium of the present invention, which comprises the first type of charged particles in non-polar liquid, can be used to form an electrophoretic device. The electrophoretic device may be an electrophoretic display, comprising an electro-optic material layer. The electro-optic material layer may have a plurality of microcapsules. Each microcapsule of the plurality of microcapsules or microcells contains electrophoretic medium. That is, the electrophoretic medium is encapsulated in microcapsules. The electrophoretic display also comprises a first light transmissive electrode layer, which can also be called front electrode, and a second electrode layer, which can also be called rear electrode. The second electrode may be light transmissive, or it may be not light transmissive. The electro-optic material layer is disposed between the first light transmissive electrode layer and the second electrode layer. The electrophoretic medium comprises the first type of charged particles in a non-polar liquid. A side view of an example of an electrophoretic device 1000 is illustrated in FIG. 10A. The electrophoretic device comprises an electro-optic material layer 1025. Electro-optic material layer 1025 comprises a plurality of microcapsules, comprising electrophoretic medium 1020, which is encapsulated in microcapsules 1050. The electrophoretic device also comprises a first light transmissive electrode layer 1010 and a second electrode layer 1040. The second electrode layer 1040 is adhered to the electro-optic material layer by an adhesive layer 1030. The electrophoretic device may comprise a second adhesive layer (not shown in FIG. 10A), which is used to adhere the first light-transmissive layer 1010 to the electro-optic material layer 1025. The electro-optic material layer 1025 may comprise, in addition to microcapsules 1050, a binder 1022. In the example of FIG. 10A, the electrophoretic medium 1020 comprises two types of particles in a non-polar liquid. One or more of the types of particles may have a core and a shell (as the first type of charged particles). The particles can be caused to move upon the application of an electric field via the electrodes 1010 and 1040.

Another example of electrophoretic device 1055, which is shown in FIG. 10B, comprises a plurality of microcells instead of microcapsules. The electrophoretic device 1055 comprises an electro-optic material layer 1026. Electro-optic material layer 1026 comprises a plurality of microcells 1056 and sealing layer 1028. Each microcell includes electrophoretic medium 1020, which is encapsulated in a plurality of microcells 1056. Each microcell 1056 of the plurality of microcells has an opening. Sealing layer 2028 spans the opening of each microcell opening. Electrophoretic device 1055 also comprises a first light transmissive electrode layer 1010 and a second electrode layer 1040. The second electrode layer 1040 may be adhered to the electro-optic material layer by an adhesive layer 1030. The electrophoretic device may comprise a second adhesive layer, which is not shown in FIG. 10B. The second adhesive layer may be used to adhere the sealing layer 1028 onto the first light-transmissive layer 1010. In the example of FIG. 10B, the electrophoretic medium 1020 comprises two types of particles in a non-polar liquid. One or more of the types of particles may have a core and a shell (as the first type of charged particles). The particles that can be caused to move upon the application of an electric field via electrodes 1010 and 1040.

The electrophoretic medium of the present invention can be used to manufacture electrophoretic assemblies, such as a front plane laminate and a double release sheet. As illustrated in FIG. 11, a front plane laminate 1100 comprises a light-transmissive electrode layer 1010, an electro-optic material layer 1025, and a release sheet 1160. The release sheet 1160 is adhered to the electro-optic material layer 1025 by an adhesive layer 1030. The electro-optic material layer 1025 may comprise, in addition to microcapsules 1050, a binder 1022. In the example of FIG. 11, the electrophoretic medium 1020 comprises two types of particles in a non-polar liquid. One or more of the types of particles may have a core and a shell (as the first type of charged particles). Removal of the release sheet 1160 and connecting a backplane, comprising an electrode layer, onto the exposed surface of the electro-optic material layer 1025 via the adhesive layer 1030, results in the formation of an electrophoretic device.

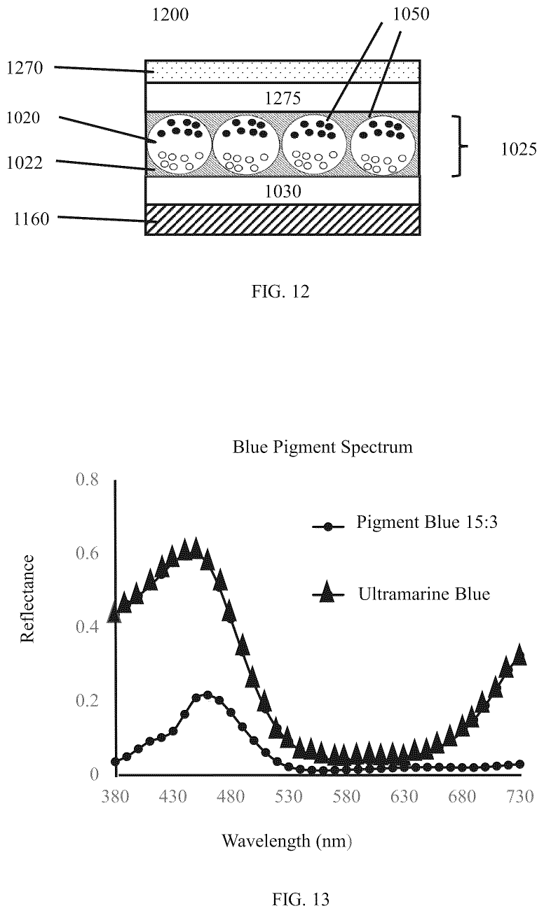

The electrophoretic medium of the present invention can be used to manufacture electrophoretic assemblies, such as a double release sheet 1200, which is illustrated in FIG. 12. Double release sheet 1200 comprises two adhesive layers (1275 and 1030) and two release sheets (1270 and 1030). Specifically, in this example, a first release sheet 1270 is attached to the electro-optic material layer 1025 using a first adhesive layer 1275. A second release sheet 1160 is attached to the electro-optic material layer 1025 using a second adhesive layer 1030. In the example of FIG. 12, the electrophoretic medium 1020 comprises two types of particles in a non-polar liquid. One or more of the types of particles may have a core and a shell, the core comprising an organic pigment core, and a shell comprising a metal oxide layer and an organosilane layer. Removal of the release sheet 1270 and connecting a first light-transmissive electrode layer onto the exposed surface of the electro-optic material layer 1025 via the adhesive layer 1275, and removal of the release sheet 1160 and connecting a backplane, comprising a second electrode, onto the exposed surface of the other side of the electro-optic material layer 1025, results in the formation of an electrophoretic device.

The electrophoretic medium of the present invention can be used to manufacture electrophoretic assemblies, such as an inverted front plane laminate. The inverted front plane laminate comprises in order (i) a first electrode layer, (ii) a first adhesive layer, (iii) an electro-optic material layer comprising an encapsulated electrophoretic medium, and (iv) and a release sheet. The inverted front plane laminate may also comprise a second adhesive layer between the electro-optic material layer and the electro-optic material layer. The inverted front plane laminate can be converted to an electro-optic device by removing the release sheet and connecting a second electrode layer onto the exposed electro-optic material layer (or onto the second adhesive layer).

The electrophoretic medium of the present invention may contain more than one type of particles, which may have different colors, charge polarities, and charge value. For example, the electrophoretic display may comprise electrophoretic medium having oppositely charged white and black particles. The electrophoretic display may comprise electrophoretic medium four different types of particles, three of which comprise organic pigments and one of which comprises inorganic pigment. The use of organic pigments is typically preferred for various colors because they provide brighter and more saturated colors in comparison to inorganic pigments. Typical organic pigments that are used in electrophoretic displays may have cyan, magenta, yellow, red, green, blue, and black color. Non-limiting examples of organic pigment types include azo, phthalocyanine, quinacridone, perylene, diketopyrrolopyrrole, benzimidazolone, isoindoline, anthranone, indanthrone, rhodamine, benzinamine, and carbon black types. Although some practitioners consider carbon black pigment as an inorganic pigment, this type of pigment is considered an organic pigment for the purpose of the present patent application, as some of its physical characteristics, such as hydrophobicity and specific surface area resemble those of an organic pigment. Non-limiting examples of specific organic pigments that may be used in electrophoretic media include C.I. Pigment Blue 15, 15:1, 15:2, 15:3, 15:4 15:6, 60, and 79; Pigment Red 2, 4, 5, 9, 12, 14, 38, 48:2, 48:3, 48:4, 52:2, 53:1, 57:1, 81, 112, 122, 144, 146, 147, 149, 168, 170, 176, 177, 179, 184, 185, 187, 188, 208, 209, 210, 214, 242, 254, 255, 257, 262, 264, 282, and 285; C.I. Pigment Violet 1, 19, 23, and 32; C.I. Pigment Yellow 1, 3, 12, 13, 14, 15, 16, 17, 73, 74, 81, 83, 97, 109, 110, 111, 120, 126, 127, 137, 138, 139, 150, 151, 154, 155, 174, 175, 176, 180, 181, 184, 191, 194, 213 and 214; C.I. Pigment Green 7, and 36; C.I. Pigment Black 1, and 7; C.I. Pigment Brown 25, 32, 41; Pigment Orange 5, 13, 34, 36, 38, 43, 61, 62, 64, 68, 67, 72, 73, and 74.

The organic pigment of the core of the first type of charged particles of the present invention may have average diameter from 10 nm up to about 100 μm, or from 50 nm to 1 μm, or from 100 nm to 800 nm.

Organic pigment provides color because they absorb specific wavelengths of incident light that correspond to visible light. Typically, their color saturation and strength increase with decreasing particle size. That is, their color saturation increases with increasing specific surface area. Thus, they are mostly available as relatively high specific surface area particles, which make them difficult to disperse and stabilize in liquids.

An electrophoretic medium of the present invention may comprise a plurality of a first type of charged particles in a non-polar liquid. Each particle comprises a core and a shell. The core comprises a first type of organic pigment having a surface and a graphene oxide layer comprising a graphene oxide, The shell comprises an organosilane layer comprising an organosilane, and a polymeric layer comprising a polymer. The polymer of the polymer layer can be formed by polymerization of a monomer. The polymer of the polymeric layer may be physically bonded to the organosilane of the organosilane layer. Alternatively, the polymer of the polymeric layer may be bonded to the organosilane of the organosilane layer via an ionic bond. That is, one of the bonded species has a positive charge, or a partially positive charge, and the other has a negative charge, or a partially negative charge. The electrophoretic medium of this embodiment may further comprise a first type of charge particles, the core of which comprises a metal oxide layer comprising a metal oxide. The metal oxide layer may be disposed between the graphene oxide layer and the organosilane layer. The metal oxide of the metal oxide layer may be covalently bonded to the organosilane of the organosilane layer. That is, the organosilane reagent that is used to form the organosilane layer comprises a first functional group that reacts with the metal oxide of the metal oxide layer, forming a covalent bond.

An electrophoretic medium of the present invention may comprise a plurality of a first type of charged particles in a non-polar liquid. Each particle comprises a core and a shell. The core comprises a first type of organic pigment having a surface and a graphene oxide layer comprising a graphene oxide. The shell comprises an organosilane layer comprising an organosilane, and a polymeric layer comprising a polymer. The polymer of the polymer layer can be formed using a macromonomer. The polymer of the polymeric layer may be covalently bonded to the organosilane of the organosilane layer. That is, a third functional group of the macromonomer can react with a second functional group of the organosilane of the organosilane layer, forming a covalent bond. The third type of particles of the electrophoretic medium may further comprise a metal oxide layer comprising a metal oxide. The metal oxide layer may be disposed between the graphene oxide layer of the core and the organosilane layer of the shell. The metal oxide of the metal oxide layer may be covalently bonded to the organosilane of the organosilane layer. That is, the organosilane reagent that is used to form the organosilane layer comprises a first functional group that reacts with the metal oxide of the metal oxide layer, forming a covalent bond.

If the first type of charged particles of the electrophoretic medium of the present invention comprises a metal oxide layer, the metal oxide may comprise aluminum oxide, silica, titanium dioxide, zirconium oxide, zinc oxide or mixtures thereof. The metal oxide may be formed by a reaction between a metal oxide precursor and a reagent. Non-limiting examples of a metal oxide precursors are trimethylaluminum, triethylaluminum, dimethylaluminum chloride, diethylaluminum chloride, trimethoxyaluminum, triethoxyaluminum, dimethylaluminum propoxide, aluminum triisopopoxide, tributoxy aluminum, tris(dimethylamino) aluminum, tris(diethylamino) aluminum, tris(propylamino) aluminum, aluminum trichloride, trichlorosilane, hexachlorodisilane, silicon tetrachloride, tetramethoxysilane, tetraethoxysilane, tris(tert-pentoxy)silanol, tetraisocyanatesilane, silicon tertrachoride, tris(methylamino)silane, tris(ethylamino)silane, titanium tetrachloride, titanium tetraiodide, tetramethoxy titanium, tetraethoxy titanium, titanium isopropoxide, tetrakis(methylamino) titanium, tetrakis(ethylamino) titanium, dimethyl zinc, diethyl zinc, methyl zinc isopropoxide, zirconium tetrachloride, zirconium tetraiodide, tetramethoxy zirconium, tetraethoxy zirconium, tetraisopropoxy zirconium, tetrabutoxy zirconium, tetrakis(methylamino) zirconium, tetrakis(ethylamino) zirconium, and mixtures thereof. Non-limiting examples of reagents are water, oxygen, ozone, ammonia, and mixture thereof. The metal oxide layer may have thickness of from about 1 nm to about 2 μm, or from about 30 nm to about 2 μm, or from about 30 nm to about 0.8 μm.

Non-limiting examples of the first functional group of the organosilane reagent that may react with the metal oxide layer are alkoxy, alkylamino, halide, hydrogen, and hydroxy. This means that a silicon atom of the organosilane may be connected to an alkoxy group, an alkylamino group, a halide group, a hydrogen group (Si—H), and a hydroxy group, respectively. The molecular structure of the organosilane reagent may contain one, two or more first functional groups. Non-limiting examples of the second functional group of the organosilane reagent are epoxy, vinyl, vinylbenzyl, acryloyl, methacryloyl, methacryloxyakyl, amino, hydroxy, carboxy, alkoxy group, and chloride. An example of a class of an organosilane reagent for bonding to the metal oxide of the metal oxide layer is trialkoxy silane coupling groups, such as 3-(trimethoxysilyl)propyl methacrylate, which is available commercially from Dow Chemical Company, Wilmington, DE under the trade name Z-6032. The first functional group of this reagent is methoxy, and the second functional group is methacrylate. The corresponding acrylate may be used. Another example of this class of silane reagent is vinylbenzylaminoethylaminopropyltrimethoxysilane, which is available by Dow Chemical Company under the trade name Dowsil™ Z-6032. In this reagent, the first functional group is methoxy, and the second functional group is vinyl. Other organosilane reagents that may be used to form the first type of charged particles are described in U.S. Patent Application No. 2018/0210312, the contents of which are incorporated herein by reference in its entirety.

The organosilane reagent that forms the organosilane layer may comprise a fourth functional group that does not participate in any reactions between the organosilane reagent with the metal oxide of the metal oxide layer or between the organosilane reagent and the monomer or macromonomer. The fourth functional group of the organosilane reagent, which may be present in the organosilane of the organosilane layer, may be useful in modifying the surface and/or providing a charge to the first type of charge particles of the electrophoretic medium. Non-limited examples of the fourth functional group of the organosilane layer are alkyl group, a halogenated alkyl group, an alkenyl group, an aryl group, a hydroxy group, a carboxy group, a sulfate group, a sulfonate group, a phosphate group, a phosphonic group, an amine group, a quaternary ammonium group, a dimethylsiloxane group, an ester group, an amide group, and ethylenimine group.

As mentioned above, the first type of charged particles of the electrophoretic medium comprises a polymeric layer that is formed by polymerization of a monomer or macromonomer. Various polymerization techniques can be used that are known to those of skill in the art. For example, the polymeric layer may be obtained by random graft polymerization (RGP), ionic random graft polymerization (IRGP), and atom transfer radical polymerization (ATRP), as described in U.S. Pat. No. 6,822,782, the contents of which are incorporated herein by reference in its entirety. As used herein throughout the specification and the claims, “macromonomer” means a macromolecule with one end-group that enables it to act as a monomer. Suitable monomers for forming the polymeric layer may include, but are not limited to, styrene, α-methyl styrene, methyl acrylate, methyl methacrylate, n-butyl acrylate, n-butyl methacrylate, t-butyl acrylate, t-butyl methacrylate, vinyl pyridine, n-vinyl pyrrolidone, 2-hydoxyethyl acrylate, 2-hydroxyethyl methacrylate, dimethylaminoethyl methacrylate, lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate, 2-perfluorobutylethyl acrylate, 2,2,2 trifluoroethyl methacrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, and 2,2,3,3,4,4,4-heptafluorobutyl methacrylate or the like. The macromonomer may contain a terminal functional group selected from the group consisting of an acrylate group, a vinyl group, or combinations thereof.

The polymer of the polymeric layer may be physically adsorbed onto the organosilane layer, covalently bonded to the organosilane of the organosilane layer, of having an electrostatic bond with the organosilane of the organosilane layer. In the case of a covalent bond, the molecular structure of the macromonomer or the polymerizable monomer contains a third functional group and the organosilane reagent contains a second functional group, the third functional group being reactive towards the second functional group. Thus, a covalent bond may be formed as the result of the reaction between the second functional group of the organosilane reagent and the third functional group. The second functional group may be epoxy, vinyl, vinylbenzyl, acryloyl, methacryloyl, methacryloxyakyl, amino, hydroxy, carboxy, alkoxy group, and chloride.

Other macromonomer reagents that may be used to form the first type of charged particles are described in U.S. Patent Application No. 2018/0210312, the contents of which are incorporated herein by reference in its entirety.

One type of macromonomer that may be used to form a polymeric layer may be acrylate terminated polysiloxane, such as Gelest, MCR-M11, MCR-M17, or MCR-M22, for example. Another type of macromonomers which is suitable for the process is PE-PEO macromonomers, as shown below:

RₘO—[CH₂CH₂O]ₙ—CH₂-phenyl-CH═CH₂; or

RₘO—[CH₂CH₂O]ₙ—C(═O)—C(CH₃)═CH₂.

The substituent R may be a polyethylene chain, n may be from 1 to 60 and m may be from 1 to 500. The synthesis of these compounds may be found in Dongri Chao et al., Polymer Journal, Vol. 23, no. 9, 1045 (1991) and Koichi Ito et al, Macromolecules, 1991, 24, 2348. A further type of suitable macromonomers is PE macromonomers, as shown below:

CH₃—[CH₂]ₙ—CH₂O—C(═O)—C(CH₃)═CH₂.

In this case, n may be from 30 to 100. The synthesis of this type of macromonomers may be found in Seigou Kawaguchi et al, Designed Monomers and Polymers, 2000, 3, 263.

When choosing a bifunctional or a multifunctional compound, such as an organosilane reagent comprising a first functional group, a second functional group, and a fourth functional group to provide polymerizable or initiating functionality on the particle, attention should be paid to the relative positions of the two groups within the reagent. As should be apparent to those skilled in polymer manufacture, the rate of reaction of a polymerizable or initiating group bonded to a particle may vary greatly depending upon whether the group is held rigidly close to the particle surface, or whether the group is spaced (on an atomic scale) from that surface and can thus extend into a reaction medium surrounding the particle. The latter is a more favorable environment for chemical reaction of the functional group. In general, it is preferred that there are at least three atoms in the direct chain between the two functional groups of the same molecule; for example, the aforementioned 3-(trimethoxysilyl)propyl methacrylate provides a chain of four carbon and one oxygen atoms between the silyl and ethylenically unsaturated groups, while the aforementioned 4-vinylaniline separates the amino group (or the diazonium group, in the actual reactive form) from the vinyl group by the full width of a benzene ring, equivalent to about the length of a three-carbon chain.

In any of the processes described above, the quantities of the reagents used (e.g., the organic core pigment particles, the graphene oxide of the graphene oxide layer, the metal oxide of the metal oxide layer, if present, the organosilane of the organosilane layer, and the monomer or macromonomer that form the polymeric layers) may be adjusted and controlled to achieve the desired content of the resulting particles. Furthermore, the processes of the present invention may include more than one stage and/or more than one type of polymerization.

As noted above, the third type of charged particles of the electrophoretic medium of the present invention are dispersed in a non-polar liquid. It is desirable that the polymeric layer be highly compatible with the non-polar liquid. The suspending non-polar liquid of an electrophoretic medium may be hydrocarbon-based, although the non-polar liquid can include a proportion of halocarbon, which is used to increase the density of the non-polar liquid and thus to decrease the difference between the density of the non-polar liquid and that of the particles. Accordingly, it is important that the polymeric layer of the first type of charged particles are compatible with the non-polar liquid, and thus that the polymeric layer itself comprise a major proportion of hydrocarbon chains; except for groups provided for charging purposes, as discussed below, large numbers of strongly ionic groups are undesirable since they render the material of the polymeric layer less soluble in the hydrocarbon suspending non-polar liquid and thus adversely affect the stability of the particle dispersion. Also, as already discussed, at least when the medium in which the particles are to be used comprises an aliphatic hydrocarbon suspending non-polar liquid, as is commonly the case, it is advantageous for the polymer of the polymeric layer to have a branched or “comb” structure, with a main chain and a plurality of side chains extending away from the main chain. Each of these side chains should have at least about four, and preferably at least about six, carbon atoms. Substantially longer side chains may be advantageous. For example, some of the preferred materials of the polymeric layer may have lauryl (C₁₂) side chains. The side chains may themselves be branched. For example, each side chain could be a branched alkyl group, such as a 2-ethylhexyl group. Although the invention is in no way limited by this belief, it is believed that, because of the high affinity of hydrocarbon chains for the hydrocarbon-based suspending non-polar liquid, the branches of the material of the polymeric layers spread out from one another in a brush or tree-like structure through a large volume of liquid, thus increasing the affinity of the particle for the suspending non-polar liquid and the stability of the particle dispersion.

There are two basic approaches to forming such a comb polymer. The first approach uses monomers, which inherently provide the necessary side chains. Typically, such a monomer has a single polymerizable group at one end of a long chain, the long chain having at least four, and preferably at least six, carbon atoms. Monomers of this type include hexyl acrylate, 2-ethylhexyl acrylate, lauryl methacrylate, and isobutyl methacrylate and 2,2,3,4,4,4-hexafluorobutyl acrylate. It may be desirable to limit the number of side chains formed in such processes, and this can be achieved by using a mixture of monomers, for example, a mixture of lauryl methacrylate and methyl methacrylate, to form a random copolymer in which only some of the repeating units bear long side chains. In another approach, typified by an RGP-ATRP process, a first polymerization reaction is carried out using a mixture of monomers, at least one of these monomers bearing an initiating group, thus producing a first polymer containing such initiating groups. The product of this first polymerization reaction is then subjected to a second polymerization, typically under different conditions from the first polymerization, to cause the initiating groups within the polymer to cause polymerization of additional monomer on to the original polymer, thereby forming the desired side chains. As with the bifunctional reagents discussed above, we do not exclude the possibility that some chemical modification of the initiating groups may be effected between the two polymerizations. In such a process, the side chains themselves do not need to be heavily branched and can be formed from a small monomer, for example methyl methacrylate.

Free radical polymerization of ethylenic or similar radical polymerizable groups attached to particles may be effected at elevated reaction temperatures, preferably 60 to 70° C., using conventional free radical initiators, such as azobis(isobutyryinitrile) (AIBN), while ATRP polymerization can be effected using the conventional metal complexes, as described in Wang, J. S., et al., Macromolecules 1995, 23, 7901, and J. Am. Chem. Soc. 1995, 117, 5614, and in Beers, K. et al., Macromolecules 1999, 32, 5772-5776. See also U.S. Pat. Nos. 5,763,548; 5,789,487; 5,807,937; 5,945,491; 4,986,015; 6,069,205; 6,071,980; 6,111,022; 6,121,371; 6,124,411; 6,137,012; 6,153,705; 6,162,882; 6,191,225; and 6,197,883. The entire disclosures of these papers and patents are herein incorporated by reference. The presently preferred catalyst for carrying out ATRP is cuprous chloride in the presence of bipyridyl (Bpy).

RGP processes of the invention in which particles bearing polymerizable groups are reacted with a monomer in the presence of an initiator may cause some formation of “free” polymer not attached to a particle, as the monomer in the reaction mixture is polymerized. The unattached polymer may be removed by repeated washings of the particles with a solvent, such as a hydrocarbon, in which the unattached polymer is soluble, or by centrifuging off the treated particles from the reaction mixture (with or without the previous addition of a solvent or diluent), redispersing the particles in fresh solvent, and repeating these steps until the proportion of unattached polymer has been reduced to an acceptable level. The decline in the proportion of unattached polymer can be followed by thermogravimetric analysis of samples of the polymer. Empirically, it does not appear that the presence of a small proportion of unattached polymer, of the order of 1 percent by weight, has any serious deleterious effect on the electrophoretic properties of the treated particles. Indeed, in some cases, depending upon the chemical nature of the unattached polymer and the suspending non-polar liquid, it may not be necessary to separate the particles having attached a polymeric layer from the unattached polymer before using the particles in an electrophoretic display.

There is an optimum range for the amount of polymeric layer, which should be formed on electrophoretic particles, and that forming an excessive amount of polymer on the particles can degrade their electrophoretic characteristics. The optimum range will vary with a number of factors, including the density and size of the particles being coated, the nature of the suspending medium in which the particles are intended to be used, and the nature of polymer formed on the particles, and for any specific particle, polymer and suspending medium, the optimum range is best determined empirically. However, by way of general guidance, it should be noted that the denser the particle, the lower the optimum proportion of polymer by weight of the particle, and the more finely divided the particle, the higher the optimum proportion of polymer. In general, the particles should be coated with at least about 2, and desirably at least about 4 percent by weight of the particle. In most cases, the optimum proportion of polymer will range from about 4 to about 15 percent by weight of the particle.

To incorporate functional groups for charge generation of the pigment particles, a co-monomer may be added to the polymerization reaction medium. The co-monomer may either directly charge the first type of charged particles or interact with a charge control agent in the non-polar liquid of the electrophoretic medium to bring a desired charge polarity and charge density to the first type of charged particles. Suitable co-monomers may include vinylbenzylaminoethylamino-propyl-trimethoxysilane, methacryloxypropyltrimethoxysilane, acrylic acid, methacrylic acid, vinyl phosphoric acid, 2-acrylamino-2-methylpropane sulfonic acid, 2-(dimethylamino)ethyl methacrylate, N-[3-(dimethylamino)propyl]methacrylamide and the like. Suitable co-monomers may also include fluorinated acrylate or methacrylate such as 2-perfluorobutylethyl acrylate, 2,2,2 trifluoroethyl methacrylate, 2,2,3,3 tetrafluoropropyl methacrylate, 1, 1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate or 2,2,3,3,4,4,4-heptafluorobutyl methacrylate. Alternatively, charged or chargeable groups may be incorporated into the polymer.

Functional groups, such as acidic or basic groups, may be provided in a “blocked” form during polymerization, and may then be de-blocked after formation of the polymer. For example, since ATRP cannot be initiated in the presence of acid, if it is desired to provide acidic groups within the polymer, esters such as t-butyl acrylate or isobornyl methacrylate may be used and the residues of these monomers within the final polymer hydrolyzed to provide acrylic or methacrylic acid residues.

When it is desired to produce charged or chargeable groups on the electrophoretic particles and also polymeric layers separately attached to the particles, it may be very convenient to treat the particles (after the metal oxide coating) with a mixture of two reagents, one of which carries the charged or chargeable group (or a group which will eventually be treated to produce the desired charged or chargeable group), and the other of which carries the polymerizable or polymerization-initiating group. Desirably, the two reagents have the same, or essentially the same, functional group which reacts with the particle surface so that, if minor variations in reaction conditions occur, the relative rates at which the reagents react with the particles will change in a similar manner, and the ratio between the number of charged or chargeable groups and the number of polymerizable or polymerization-initiating groups will remain substantially constant. It will be appreciated that this ratio can be varied and controlled by varying the relative molar amounts of the two or more reagents used in the mixture. Examples of reagents which provide chargeable sites but not polymerizable or polymerization-initiating groups include 3-(trimethoxysilyl)propylamine, N-[3-(trimethoxysilyl)propyl]diethylenetriamine, N-[3-(trimethoxysilyl)propyl]ethylene and 1-[3-(trimethoxysilyl)propyl]urea; all these organosilane reagents may be purchased from United Chemical Technologies, Inc., Bristol, Pa., 19007. As already mentioned, an example of a reagent, which provides polymerizable groups but not charged or chargeable groups, is 3-(trimethoxysilyl)propyl methacrylate.

The first type of charged particles of the present invention are useful in electrophoretic devices. Firstly, the shell of the particles enables the modification and control of the surface nature and charge of the organic pigment. Thus, different types of electrophoretic particles in a medium may be surface modified using different silane treatments, which may contribute to an effective separation and, as a result, an improved electro-optic performance. The metal oxide layer enables the covalent bond of the organosilane layer onto the particle surface. By precipitating a layer of a metal oxide onto the surface of the organic pigment-graphene oxide complex, the subsequent organosilane layer is strongly attached to the surface of the complex. It is unlikely that the organosilane will be desorbed from the surface of the organic pigment-graphene oxide complex, increasing the effectiveness of the surface treatment. The same is true for surface treatments that include a polymeric layer. The polymeric layer contributes to the stability of the particle dispersion because it protects against particle aggregation. Steric effects, caused by the polymer attachment on the pigment particle surfaces, prevent the particles from aggregating. The stronger the attachment, the more effective the stabilization is, because less desorption of the polymer from the particle surface is observed with stronger attachment. Thus, in the case of a covalent bond of the polymer to the particle surface, a more effective particle stabilization and improved electro-optic performance is observed.

The amount of polymeric layer on the first type of charged particles may be controlled. Forming an excessive amount of polymer on the particles can degrade their electrophoretic characteristics. The optimum range will vary with a number of factors, including the density and size of the organic pigment, the density and thickness of the metal oxide layer, the nature of the non-polar liquid of the electrophoretic medium, and the nature of polymer of the polymeric layer. It was previously found that the denser the particle, the lower the optimum proportion of polymeric layer by weight of the charged particle. In addition, the more finely divided the organic pigment core, the higher the optimum proportion of polymeric layer. The polymeric layer may be from 1 to 50 weight percent, or from 2 to 30 weight percent, or from 3 to 20, or from 4 to 15 weight percent by weight of the first type of charged particle.

The non-polar liquid, in which the electrophoretic particles are dispersed, may be clear and colorless. It preferably has a dielectric constant in the range of about 2 to about 30, preferably about 2 to about 15 for high particle mobility. Examples of suitable dielectric solvent include hydrocarbons such as isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzotri fluoride, chloropentafluoro-benzene, dichlorononane or pentachlorobenzene, and perfluorinated solvents such as FC-43, FC-70 or FC-5060 from 3M Company, St. Paul MN, low molecular weight halogen containing polymers such as poly(perfluoropropylene oxide) from TCI America, Portland, Oregon, poly(chlorotrifluoro-ethylene) such as Halocarbon Oils from Halocarbon Product Corp., River Edge, NJ, perfluoropolyalkylether such as Galden from Ausimont or Krytox Oils and Greases K-Fluid Series from DuPont, Delaware, polydimethylsiloxane based silicone oil from Dow-corning (DC-200).

The content of the electrophoretic particles in the non-polar liquid may vary. For example, one type of particles may take up 0.1% to 50%, preferably 0.5% to 15%, by volume of the non-polar liquid.

### EXAMPLES

Examples of the present invention are described below. The present invention is not limited to the Examples.

### Example 1

Preparation of Particles of Blue 15:3-Graphene Oxide Complex: A commercial sample of Graphene Oxide was mixed with ethanol and the mixture was sonicated to disperse the graphene oxide. A commercial sample of Pigment Blue 15:3 powder was slowly added into the graphene oxide dispersion and heated to 50° C. under mixing for 5 hours to produce a dispersion comprising Pigment Blue 15:3-Graphne Oxide complex.

### Example 2

Preparation of Particles Comprising Blue 15:3-Graphene Oxide Complex and Silica Layer: Into the dispersion prepared in Example 1, tetraethyl orthosilicate (TEOS) and ammonium hydroxide were added and mixed for 1 hour.

### Example 3

Preparation of Particles Comprising Pigment Blue 15:3-Graphene Oxide Complex, Silica Layer, and Organosilane Layer: Into the dispersion prepared in Example 2, 3-(trimethoxysilyl)propyl methacrylate was added and stirred to prepare an ethanolic dispersion of particles comprising Pigment Blue 15:3-graphene oxide complex, a silica layer, and an organosilane layer.

### Example 4

Solvent Transfer: The dispersion from Example 3 was washed three times with ethanol, centrifuged, and the supernatant ethanol was removed. The resulting paste was washed three times with toluene, centrifuged, and the supernatant ethanol was removed. The paste was diluted with additional toluene.

### Example 5

Preparation of First Type of Charged Particles: Into the dispersion prepared in Example 4, lauryl methacrylate monomer and radical initiator 2,2′-azobis (2-methylpropionitrile). The mixture was placed nitrogen and then stirred at 70° C. for 20 hours. The dispersion was then washed three times with Isopar E (hydrocarbon solvent), centrifuged after each wash, diluted with Isopar E, sonicated, and then oven-dried at 50° C.

A variety of experiments of Examples 1-5 were performed, using different amounts of Pigment Blue 15:3, graphene oxide, TEOS, 3-(trimethoxysilyl)propyl methacrylate, and lauryl methacrylate. Table 1 summarizes the relative amounts of the materials in the final particles, as determined by thermogravimetric analysis.

TABLE 1
Compositions of First Type of Charged
Particles from Various Experiments

| | Graphene | | | Poly(lauryl |
|---|---|---|---|---|
| Electrophoretic | Oxide | Silica | Silane | methacrylate) |
| Cyan Pigment | wt % | wt % | wt % | wt % |
| Ex. 5A | 2.5 | 37.8 | 1.0 | 7.4 |
| Ex. 5B | 2.5 | 36.2 | 4.9 | 8.1 |
| Ex. 5C | 2.5 | 35.7 | 4.9 | 7.0 |
| Ex. 5C | 2.5 | 32.6 | 0.7 | 7.1 |
| Ex. 5D | 1.25 | 35.5 | 3.3 | 8.2 |
| Comparative Ex. 5E | 0.0 | 0.0 | 12.0 | 6.6 |
| Comparative Ex. 5F | 5.0 | 33.3 | 0.0 | 4.9 |

### Example 6

Performance Evaluation of Particles from Example 5

In order to observe its performance of the blue particles from Example 5, a three-pigment dispersion was prepared using the following composition: 5 wt % blue pigment, 30% white pigment, 12% yellow pigment and 0.25% charge control agent (Solsperse™ 19,000). Furthermore, a control dispersion was prepared using the same compositions, but replacing the inventive blue particles with control pigment particles. The control pigment particles were prepared from Pigment Blue 15:3 and lauryl methacrylate, using a dispersion polymerization method. All dispersions were sonicated and vortexed before further evaluation. Electrophoretic devices were prepared using the dispersions comprising (a) blue particles from Example 5D, blue particles from Comparative Example 5E, and control blue particles from dispersion polymerization. The corresponding electrophoretic devices were driven to blue state, white state, yellow state, and green state, and the color in L*a*b* values of each state was measured via a colorimeter (reflection). Tables 2, 3, and 4 summarize the color evaluation of the three dispersions.

TABLE 2
Color Measurements of Dispersion Using Control Blue Particles
(Dispersion Polymerization); Dispersion: 5% Blue, 25%
White, 12% Yellow, 0.25% Solsperse ™ 19,000.

| | Blue State | White State | Yellow State | Green State |
|---|---|---|---|---|
| L* | 2.5 | 37.8 | 1.0 | 7.4 |
| a* | 2.5 | 36.2 | 4.9 | 8.1 |
| b* | 2.5 | 35.7 | 4.9 | 7.0 |

TABLE 3
Color Measurements of Dispersion Using Blue Particles
from Comparative Example 3F; Dispersion: 5% Blue,
30% White, 12% Yellow, 0.25% Solsperse ™ 19,000.

| | Blue State | White State | Yellow State | Green State |
|---|---|---|---|---|
| L* | 45.7 | 63.4 | 66.7 | 26.9 |
| a* | −38.7 | −8.5 | −19.6 | −59.1 |
| b* | −14.9 | −5.5 | 40.2 | 13.0 |

TABLE 4
Color Measurements of Dispersion Using Blue Particles
from Inventive Example 3D; Dispersion: 5% Blue, 30%
White, 12% Yellow, 0.25% Solsperse ™ 19,000.

| | Blue State | White State | Yellow State | Green State |
|---|---|---|---|---|
| L* | 47.8 | 65.1 | 64.9 | 26.4 |
| a* | −33.6 | −5.5 | −21.0 | −64.7 |
| b* | −17.9 | −4.0 | 52.3 | 11.7 |

From the data of Tables 2-4, it is shown that the blue state of inventive dispersion of Table 4 has the highest chroma (lowest b* value). The Yellow state of inventive dispersion of Table 4 also has the highest chroma (highest b* value). The excellent yellow state that was observed from the inventive demonstrates that there is a better separation of the blue particles from the yellow particles in the electrophoretic device, leading to more chromatic blue and yellow states. Furthermore, the green state of inventive dispersion of Table 4 also has the highest chroma (lowest a* value), leading to a more desirable green color.

To further examine the role of the graphene oxide in the performance of the blue particles, inventive dispersion that comprises blue particles from Example 5D were compared to control dispersion comprising blue particles prepared similarly to the ones of Example 5D but using poly(vinyl pyrrolidone) instead of the graphene oxide. PVP is often used as a polymeric surfactant for forming organic pigment dispersions of good color quality. The control (PVP-containing blue particles) and the inventive particles from Example 5D were used for the preparation of dispersion comprising three pigments (Blue, White, and Yellow). That is, electrophoretic devices were prepared using these two dispersions and the electrophoretic devices were driven to blue state, white state, yellow state, and green state. The color in L*a*b* values of each state was measured via a colorimeter (reflection). Tables 5 and 6 summarize the color evaluation of the two dispersions.

TABLE 5
Color Measurements of Dispersion Using Control Blue Particles
Comprising PVP Instead or Graphene Oxide; Dispersion: 5%
Blue, 30% White, 10% Yellow, 0.25% Solsperse ™ 19,000.

| | Blue State | White State | Yellow State | Green State |
|---|---|---|---|---|
| L* | 43.1 | 63.3 | 63.7 | 24.7 |
| a* | −36.9 | −9.9 | −9.5 | −58.6 |
| b* | −7.7 | 13.8 | 14.3 | 10.3 |

TABLE 6
Color Measurements of Dispersion Using Control Blue Particles
Comprising Graphene Oxide (from Example 5D); Dispersion: 5%
Blue, 30% White, 10% Yellow, 0.25% Solsperse ™ 19,000.

| | Blue State | White State | Yellow State | Green State |
|---|---|---|---|---|
| L* | 39.8 | 64.7 | 63.5 | 38.9 |
| a* | −29.7 | −12.7 | −20.2 | −53.4 |
| b* | −30.0 | −2.2 | 39.3 | 28.5 |

The dispersion containing the control blue particles (comprising PVP instead of graphene oxide) shows significant aggregation with yellow pigment, as evidenced by the higher b* value of the blue state and the lower b* value of the yellow state (Table 5), compared to the dispersion that contain the inventive blue particles (Table 6).

Thus, significant improvements in the color quality of electrophoretic devices are observed. The improvements are achieved using the blue particles of the present invention. Without wishing to be bound by theory, the beneficial effect of the graphene oxide of the graphene oxide layer may be a result of strong hydrophobic and/or π-π interactions between the extended aromatic system of copper phthalocyanine pigment (and other organic pigments) and the graphene oxide. Thus, graphene oxide may effectively cover a large part of the pigment particle surface. At the same time, the hydrophilic polar groups of the graphene oxide may be compatible with polar groups of other materials that are used in the surface modification of the electrophoretic particles, such as organosilanes, metal oxides, and others. This facilitates the quality of the surface modification of the particle, leading to an excellent separation between particles of the same and different types.

The technology of the present invention enables the use of copper phthalocyanine blue in electrophoretic displays. The technology mitigates the aggregation between organic pigment particles of different colors (blue-red and blue-yellow), which was observed when copper phthalocyanine blue pigments are used that have surface treatments different from that of the technology of the present invention. Another way to mitigate the aggregation phenomenon is to use an inorganic pigment, such as ultramarine blue. However, even if it is easier to separate inorganic blue pigment particles from organic pigment particles in an electrophoretic medium because of the different nature of the surface between an inorganic pigment particle and an organic pigment particle, the use of inorganic pigments, such as ultramarine blue, is not desirable. Copper phthalocyanine blue offers a much better choice, because it attains much higher chroma than ultramarine blue (and all other inorganic pigments), enabling better image quality. As shown in FIG. 11, the visible reflectance spectrum of copper phthalocyanine (Pigment Blue 15:3) versus wavelength shows high intensity in the blue wavelength region and almost no reflectance in the red region, the red region corresponding to wavelengths that are higher than 680 nm. On the contrary, the corresponding reflectance curve of ultramarine blue pigment shows a strong reflectance in the red region. This means that Pigment Red 15:3 shows better performance in electrophoretic systems that contain multiple color pigment particles, such as a four-pigment system for full color electrophoretic displays. For example, in systems where the black state is created by the reflection of multiple color particles (red, blue, and yellow), the use of Pigment Blue 15:3 enables an excellent black state without a red shade. Furthermore, the use of Pigment Blue 15:3 in multi-pigment electrophoretic media enables an excellent green state form mixing yellow and blue.

To investigate the feasibility of using the technology of the present invention in pigments other than phthalocyanines, the corresponding particles were prepared comprising pyrroles-based pigments, such as Pigment Red 254 (1,4-bis(4-chlorophenyl)-2,5-dihydropyrrolo[3,4-c]pyrrole-3,6-dione). The preparation included synthesis particles comprising Pigment-Red 254-graphene oxide complex, mixing of the complex with organosilane (Z-6032), and graft polymerization using ethyl hexyl acrylate monomer (EHA) in the presence of AIBN. The polymerization of ethyl hexyl acrylate monomer provides poly(ethyl hexyl acrylate) or PEHA. The weight percent content of the different layers of the prepared particles are provided in Table 7, wherein the inventive particles correspond to Example 6. Control red particles (Comparative Examples 7 and 8) were also prepared, using the same organic pigment of the core, organosilane reagent and monomer for the shell, but not including the graphene oxide layer.

TABLE 7
Compositions of Charged Particles Based on Pigment Red 254

| | Graphene Oxide | Organosilane | PEHA |
|---|---|---|---|
| | wt % | wt % | wt % |
| Example 6 | 1.25 | 30.2 | 14.7 |
| Comparative Example 7 | 0 | 2.7 | 8.9 |
| Comparative Example 8 | 0 | 3.4 | 11.3 |

There is a noticeable difference between the contents of the particles of Comparative Examples 7 and 8 and that of inventive Example 6 in the amount of the organosilane that was incorporated on the pigment surface, although the ratio of pigment to organosilane used was similar for all three examples. The data of Table 7 demonstrate that graphene oxide enables a strong interaction between the hydrophobic pigment particle surface and the more hydrophilic organosilane reagent, which result in an effectively incorporation of the organosilane of the particle.

In conclusion, the technology of the present invention enables good electrophoretic performance of charged particles comprising organic pigments.

### CLAUSES

Clause 1: An electrophoretic medium comprising a plurality of a first type of charged particles and a non-polar liquid, each of the plurality of the first type of charged particles having a core and a shell, the core comprising a first type of organic pigment having a surface, a graphene oxide layer comprising graphene oxide, the graphene oxide layer being in contact with the surface of the first type of the organic pigment; the shell comprising an organosilane layer and a polymeric layer, the organosilane layer comprising an organosilane, and the polymeric layer comprising a polymer, the organosilane of the organosilane layer of the shell being covalently bonded to the polymer of polymeric layer.
Clause 2: The electrophoretic medium of clause 1, further comprising a metal oxide layer comprising a metal oxide, the metal oxide layer being disposed between the graphene oxide layer and the organosilane layer.
Clause 3: The electrophoretic medium according to clause 2, wherein the metal oxide layer comprises aluminum oxide, silica, titanium dioxide, zirconium oxide, zinc oxide or mixtures thereof.
Clause 4: The electrophoretic medium according to clause 2 or clause 3, wherein the metal oxide of the metal oxide layer of the first type of charged particles is formed on the graphene oxide layer by a reaction of a metal oxide precursor and a reagent, the reagent reacting with the metal oxide precursor to form the metal oxide of the metal oxide layer, wherein the metal oxide of the metal oxide layer is in contact with the graphene oxide of the graphene oxide layer, wherein the metal oxide precursor is selected from the group consisting of trimethylaluminum, triethylaluminum, dimethylaluminum chloride, diethylaluminum chloride, trimethoxyaluminum, triethoxyaluminum, dimethylaluminum propoxide, aluminum triisopopoxide, tributoxy aluminum, tris(dimethylamino) aluminum, tris(diethylamino) aluminum, tris(propylamino) aluminum aluminum, trichloride, trichlorosilane, hexachlorodisilane, silicon tetrachloride, tetramethoxysilane, tetraethoxysilane, tris(tert-pentoxy) silanol, tetraisocyanatesilane, silicon tertrachoride, tris(methylamino)silane, tris(ethylamino)silane, titanium tetrachloride, titanium tetraiodide, tetramethoxy titanium, tetraethoxy titanium, titanium isopropoxide, tetrakis(methylamino) titanium, tetrakis(ethylamino) titanium, dimethyl zinc, diethyl zinc, methyl zinc isopropoxide, zirconium tetrachloride, zirconium tetraiodide, tetramethoxy zirconium, tetraethoxy zirconium, tetraisopropoxy zirconium, tetrabutoxy zirconium, tetrakis(methylamino) zirconium, tetrakis(ethylamino) zirconium, and mixtures thereof, wherein the reagent is selected from the group consisting of water, oxygen, ozone, ammonia, and mixture thereof, and wherein the organosilane of the organosilane layer is covalently bonded to the metal oxide of the metal oxide layer.
Clause 5: The electrophoretic medium according to any one of clause 2 to clause 4, wherein the organosilane layer is formed from an organosilane reagent, wherein the organosilane reagent comprises a first functional group, the first functional group of the organosilane reagent reacting with the metal oxide of the metal oxide layer to form a covalent bond between the organosilane of the organosilane layer and the metal oxide of the metal oxide layer of the first type of charged particles.
Clause 6: The electrophoretic medium of clause 5, wherein the first functional group of the organosilane reagent is selected from the group consisting of alkoxy, alkylamino, halide, hydrogen, and hydroxy.
Clause 7: The electrophoretic medium according to any one of clause 1 to clause 6, wherein the polymer of the polymeric layer is formed from a macromonomer or from polymerization of a monomer.
Clause 8: The electrophoretic medium of clause 7, wherein the organosilane reagent comprises a second functional group, wherein the macromonomer or the monomer comprises a third functional group, and wherein the second functional group reacts with the third functional group to form a covalent bond between the organosilane of the organosilane layer and the polymer of the polymeric layer of the first type of charged particles.
Clause 9: The electrophoretic medium of clause 8, wherein the second functional group of the organosilane reagent is selected from the group consisting of epoxy, vinyl, vinylbenzyl, acryloyl, methacryloyl, methacryloxyakyl, amino, hydroxy, carboxy, alkoxy group, and chloride.
Clause 10: The electrophoretic medium according to clause 8 or clause 9, wherein the third functional group of the monomer or macromonomer is selected from the group consisting of vinyl, vinylbenzyl, acryloyl, methacryloyl, methacryloxyakyl, epoxy, amino, hydroxy, carboxy, and chloride.
Clause 11: The electrophoretic medium of clause 8, wherein the second functional group of the organosilane is vinyl and the third functional group of the macromonomer or monomer is vinylbenzyl.
Clause 12: The electrophoretic medium according to any one of clause 1 to clause 11, further comprising a plurality of a second type of charged particles, a plurality of a third type of charged particles, and a plurality of a fourth type of charged particles.
Clause 13: The electrophoretic medium of clause 12, wherein each of the plurality of the second type of charged particles comprises a second type of organic pigment, each of the plurality of the third type of charged particles comprises a third type of organic pigment, and each of the plurality of the fourth types of charged particles comprises an inorganic pigment.
Clause 14: The electrophoretic medium according to any one of clause 1 to clause 13, wherein the first type of organic pigment is selected from the group consisting of an azo pigment, a phthalocyanine pigment, a quinacridone pigment, a perylene pigment, a diketopyrrolopyrrole pigment, a benzimidazolone pigment, an isoindoline pigment, an anthranone pigment, an indanthrone pigment, a carbon black pigment, a rhodamine pigment, a benzinamine pigment, a carbon black pigments, and mixtures therein.
Clause 15: The electrophoretic medium according to clause 13 or clause 14, wherein the first type of organic pigment, the second type of organic pigment, and the third type of organic pigment are independently selected from the group consisting of C.I. Pigment Blue 15, 15:1, 15:2, 15:3, 15:4 15:6, 60, and 79; Pigment Red 2, 4, 5, 9, 12, 14, 38, 48:2, 48:3, 48:4, 52:2, 53:1, 57:1, 81, 112, 122, 144, 146, 147, 149, 168, 170, 176, 177, 179, 184, 185, 187, 188, 208, 209, 210, 214, 242, 254, 255, 257, 262, 264, 282, and 285; C.I. Pigment Violet 1, 19, 23, and 32; C.I. Pigment Yellow 1, 3, 12, 13, 14, 15, 16, 17, 73, 74, 81, 83, 97, 109, 110, 111, 120, 126, 127, 137, 138, 139, 150, 151, 154, 155, 174, 175, 176, 180, 181, 184, 191, 194, 213 and 214; C.I. Pigment Green 7, and 36; C.I. Pigment Black 1, and 7; C.I. Pigment Brown 25, 32, 41; Pigment Orange 5, 13, 34, 36, 38, 43, 61, 62, 64, 68, 67, 72, 73, and 74, and mixtures thereof.
Clause 16: An electrophoretic device comprising a first light-transmissive electrode layer; an electro-optic material layer comprising the electrophoretic medium according to any one of clause 1 to clause 15; and a second electrode layer.
Clause 17: The electrophoretic device of clause 16, wherein the electrophoretic medium of the electro-optic material layer is encapsulated in a plurality of microcapsules or in a plurality of microcells.
Clause 18: An electrophoretic assembly comprising in order: a first light-transmissive electrode layer; an electro-optic material layer comprising the electrophoretic medium according to any one of clause 1 to clause 15; an adhesive layer; and a release sheet.
Clause 19: An electrophoretic assembly comprising in order: a first release sheet; a first adhesive layer; an electro-optic material layer comprising the electrophoretic medium according to any one of clause 1 to clause 15; a second adhesive layer; and a second release sheet.
Clause 20: A method of manufacturing of an electrophoretic medium comprising a non-polar liquid and a first type of charged particles, the first type of charged particles having a core and a shell, the method of manufacturing comprising the steps: (a) providing graphene oxide; (b) dispersing the graphene oxide into a polar organic solvent to make a graphene oxide dispersion; (c) adding an organic pigment into the graphene oxide dispersion to prepare an organic pigment-graphene oxide dispersion; (d) mixing the organic pigment-graphene oxide dispersion to prepare an organic pigment-graphene oxide complex in the polar organic solvent; (c) adding a metal oxide precursor and a reagent into the organic pigment-graphene oxide complex in the polar organic solvent to prepare a dispersion of particles comprising organic pigment-graphene oxide complex having a metal oxide layer, the metal oxide layer comprising a metal oxide; (f) adding an organosilane reagent into the dispersion of particles comprising the organic pigment-graphene oxide complex having the metal oxide layer to prepare a dispersion having particles comprising the organic pigment-graphene oxide complex having the metal oxide layer and an organosilane layer, the organosilane layer having an organosilane, wherein the organosilane is covalently bonded to the metal oxide; (g) separating the particles comprising the organic pigment-graphene oxide complex having the metal oxide layer and an organosilane layer from the polar organic solvent; (h) washing the particles comprising the organic pigment-graphene oxide complex having the metal oxide layer and the organosilane layer with a solvent; (i) transferring the washed particles comprising the organic pigment-graphene oxide complex having the metal oxide layer and the organosilane layer into a non-polar liquid to prepare a dispersion of particles comprising the organic pigment-graphene oxide complex having the metal oxide layer and the organosilane layer in the non-polar liquid; (j) adding a monomer or a macromonomer into the dispersion of particles comprising the organic pigment-graphene oxide complex having the metal oxide layer and the organosilane layer in the non-polar liquid; and (k) polymerizing the monomer or reacting the macromonomer with the organosilane of the organosilane layer of the particles comprising the organic pigment-graphene oxide complex having the metal oxide layer and the organosilane layer to prepare a dispersion comprising the first type of charged particles in the non-polar liquid, each of the first type of charged particles comprising the organic pigment-graphene oxide complex having the metal oxide layer, the organosilane layer, and a polymeric layer, the polymeric layer comprising a polymer, the polymer being covalently bonded to the organosilane of the organosilane layer.

What is claimed is:

1. An electrophoretic medium comprising a plurality of a first type of charged particles and a non-polar liquid, each of the plurality of the first type of charged particles having a core and a shell,
the core comprising a first type of organic pigment having a surface, a graphene oxide layer comprising graphene oxide, the graphene oxide layer being in contact with the surface of the first type of the organic pigment;
the shell comprising an organosilane layer and a polymeric layer, the organosilane layer comprising an organosilane, and the polymeric layer comprising a polymer, the organosilane of the organosilane layer of the shell being covalently bonded to the polymer of polymeric layer.

2. The electrophoretic medium of claim 1, further comprising a metal oxide layer comprising a metal oxide, the metal oxide layer being disposed between the graphene oxide layer and the organosilane layer.

3. The electrophoretic medium of claim 2, wherein the metal oxide layer comprises aluminum oxide, silica, titanium dioxide, zirconium oxide, zinc oxide or mixtures thereof.

4. The electrophoretic medium of claim 2, wherein the metal oxide of the metal oxide layer of the first type of charged particles is formed on the graphene oxide layer by a reaction of a metal oxide precursor and a reagent, the reagent reacting with the metal oxide precursor to form the metal oxide of the metal oxide layer, wherein the metal oxide of the metal oxide layer is in contact with the graphene oxide of the graphene oxide layer, wherein the metal oxide precursor is selected from the group consisting of trimethylaluminum, triethylaluminum, dimethylaluminum chloride, diethylaluminum chloride, trimethoxyaluminum, triethoxyaluminum, dimethylaluminum propoxide, aluminum triisopopoxide, tributoxy aluminum, tris(dimethylamino) aluminum, tris(diethylamino) aluminum, tris(propylamino) aluminum, aluminum trichloride, trichlorosilane, hexachlorodisilane, silicon tetrachloride, tetramethoxysilane, tetraethoxysilane, tris(tert-pentoxy)silanol, tetraisocyanatesilane, silicon tertrachoride, tris(methylamino)silane, tris(ethylamino)silane, titanium tetrachloride, titanium tetraiodide, tetramethoxy titanium, tetraethoxy titanium, titanium isopropoxide, tetrakis(methylamino) titanium, tetrakis(ethylamino) titanium, dimethyl zinc, diethyl zinc, methyl zinc isopropoxide, zirconium tetrachloride, zirconium tetraiodide, tetramethoxy zirconium, tetraethoxy zirconium, tetraisopropoxy zirconium, tetrabutoxy zirconium, tetrakis(methylamino) zirconium, tetrakis(ethylamino) zirconium, and mixtures thereof, wherein the reagent is selected from the group consisting of water, oxygen, ozone, ammonia, and mixture thereof, and wherein the organosilane of the organosilane layer is covalently bonded to the metal oxide of the metal oxide layer.

5. The electrophoretic medium of claim 2, wherein the organosilane layer is formed from an organosilane reagent, wherein the organosilane reagent comprises a first functional group, the first functional group of the organosilane reagent reacting with the metal oxide of the metal oxide layer to form a covalent bond between the organosilane of the organosilane layer and the metal oxide of the metal oxide layer of the first type of charged particles.

6. The electrophoretic medium of claim 5, wherein the first functional group of the organosilane reagent is selected from the group consisting of alkoxy, alkylamino, halide, hydrogen, and hydroxy.

7. The electrophoretic medium of claim 1, wherein the polymer of the polymeric layer is formed from a macromonomer or from polymerization of a monomer.

8. The electrophoretic medium of claim 7, wherein the organosilane reagent comprises a second functional group, wherein the macromonomer or the monomer comprises a third functional group, and wherein the second functional group reacts with the third functional group to form a covalent bond between the organosilane of the organosilane layer and the polymer of the polymeric layer of the first type of charged particles.

9. The electrophoretic medium of claim 8, wherein the second functional group of the organosilane reagent is selected from the group consisting of epoxy, vinyl, vinylbenzyl, acryloyl, methacryloyl, methacryloxyakyl, amino, hydroxy, carboxy, alkoxy group, and chloride.

10. The electrophoretic medium of claim 8, wherein the third functional group of the monomer or macromonomer is selected from the group consisting of vinyl, vinylbenzyl, acryloyl, methacryloyl, methacryloxyakyl, epoxy, amino, hydroxy, carboxy, and chloride.

11. The electrophoretic medium of claim 8, wherein the second functional group of the organosilane is vinyl and the third functional group of the macromonomer or monomer is vinylbenzyl.

12. The electrophoretic medium of claim 1, further comprising a plurality of a second type of charged particles, a plurality of a third type of charged particles, and a plurality of a fourth type of charged particles.

13. The electrophoretic medium of claim 12, wherein each of the plurality of the second type of charged particles comprises a second type of organic pigment, each of the plurality of the third type of charged particles comprises a third type of organic pigment, and each of the plurality of the fourth types of charged particles comprises an inorganic pigment.

14. The electrophoretic medium of claim 1, wherein the first type of organic pigment is selected from the group consisting of an azo pigment, a phthalocyanine pigment, a quinacridone pigment, a perylene pigment, a diketopyrrolopyrrole pigment, a benzimidazolone pigment, an isoindoline pigment, an anthranone pigment, an indanthrone pigment, a carbon black pigment, a rhodamine pigment, a benzinamine pigment, a carbon black pigments, and mixtures therein.

15. The electrophoretic medium according to claim 13, wherein the first type of organic pigment, the second type of organic pigment, and the third type of organic pigment are independently selected from the group consisting of C.I. Pigment Blue 15, 15:1, 15:2, 15:3, 15:4 15:6, 60, and 79; Pigment Red 2, 4, 5, 9, 12, 14, 38, 48:2, 48:3, 48:4, 52:2, 53:1, 57:1, 81, 112, 122, 144, 146, 147, 149, 168, 170, 176, 177, 179, 184, 185, 187, 188, 208, 209, 210, 214, 242, 254, 255, 257, 262, 264, 282, and 285; C.I. Pigment Violet 1, 19, 23, and 32; C.I. Pigment Yellow 1, 3, 12, 13, 14, 15, 16, 17, 73, 74, 81, 83, 97, 109, 110, 111, 120, 126, 127, 137, 138, 139, 150, 151, 154, 155, 174, 175, 176, 180, 181, 184, 191, 194, 213 and 214; C.I. Pigment Green 7, and 36; C.I. Pigment Black 1, and 7; C.I. Pigment Brown 25, 32, 41; Pigment Orange 5, 13, 34, 36, 38, 43, 61, 62, 64, 68, 67, 72, 73, and 74, and mixtures thereof.

16. An electrophoretic device comprising
a first light-transmissive electrode layer;
an electro-optic material layer comprising the electrophoretic medium of claim 1; and
a second electrode layer.

17. The electrophoretic device of claim 16, wherein the electrophoretic medium of the electro-optic material layer is encapsulated in a plurality of microcapsules or in a plurality of microcells.

18. An electrophoretic assembly comprising in order:
a first light-transmissive electrode layer;
an electro-optic material layer comprising the electrophoretic medium of claim 1;
an adhesive layer; and
a release sheet.

19. An electrophoretic assembly comprising in order:
a first release sheet;
a first adhesive layer;
an electro-optic material layer comprising the electrophoretic medium of claim 1;
a second adhesive layer; and
a second release sheet.

20. A method of manufacturing of an electrophoretic medium comprising a non-polar liquid and a first type of charged particles, the first type of charged particles having a core and a shell, the method of manufacturing comprising the steps:
providing graphene oxide;
dispersing the graphene oxide into a polar organic solvent to make a graphene oxide dispersion;
adding an organic pigment into the graphene oxide dispersion to prepare an organic pigment-graphene oxide dispersion;
mixing the organic pigment-graphene oxide dispersion to prepare an organic pigment-graphene oxide complex in the polar organic solvent;
adding a metal oxide precursor and a reagent into the organic pigment-graphene oxide complex in the polar organic solvent to prepare a dispersion of particles comprising organic pigment-graphene oxide complex having a metal oxide layer, the metal oxide layer comprising a metal oxide;
adding an organosilane reagent into the dispersion of particles comprising the organic pigment-graphene oxide complex having the metal oxide layer to prepare a dispersion having particles comprising the organic pigment-graphene oxide complex having the metal oxide layer and an organosilane layer, the organosilane layer having an organosilane, wherein the organosilane is covalently bonded to the metal oxide;
separating the particles comprising the organic pigment-graphene oxide complex having the metal oxide layer and an organosilane layer from the polar organic solvent;
washing the particles comprising the organic pigment-graphene oxide complex having the metal oxide layer and the organosilane layer with a solvent;
transferring the washed particles comprising the organic pigment-graphene oxide complex having the metal oxide layer and the organosilane layer into a non-polar liquid to prepare a dispersion of particles comprising the organic pigment-graphene oxide complex having the metal oxide layer and the organosilane layer in the non-polar liquid;
adding a monomer or a macromonomer into the dispersion of particles comprising the organic pigment-graphene oxide complex having the metal oxide layer and the organosilane layer in the non-polar liquid; and
polymerizing the monomer or reacting the macromonomer with the organosilane of the organosilane layer of the particles comprising the organic pigment-graphene oxide complex having the metal oxide layer and the organosilane layer to prepare a dispersion comprising the first type of charged particles in the non-polar liquid, each of the first type of charged particles comprising the organic pigment-graphene oxide complex having the metal oxide layer, the organosilane layer, and a polymeric layer, the polymeric layer comprising a polymer, the polymer being covalently bonded to the organosilane of the organosilane layer.
